(19) United States
(12) Patent Application Publication
(10) Pub. No.: US 2002/0032783 A1
(43) Pub. Date: Mar. 14, 2002

(54) Shared service funtionality invocation

(76) Inventor: Jeffrey T. Tuatini, San Francisco, CA (US)

Correspondence Address: PERKINS COIE LLP, PATENT-SEA, P.O. BOX 1247, SEATTLE, WA, 98111-1247, US

(21) Appl. No.: 09/755,621

(22) Filed: Jan. 2, 2001

Related U.S. Application Data
(60) Provisional application No. 60/173,666, filed on Dec. 30, 1999.
(60) Provisional application No. 60/173,712, filed on Dec. 30, 1999.

(51) Int. Cl. G06F 15/16; G06F 15/173

(52) U.S. Cl. 709/229; 709/225

(57) ABSTRACT

An application architecture allowing applications to inter-communicate is provided. The application framework receives requests for services from clients, identifies application action handler components that can service the requests and application view handler components that can format the responses, invokes the identified action handlers to service the requests, and invokes identified view handlers to format and send the responses to the clients. When an application component needs to access functionality provided by remote shared services, the component uses a local messaging service to communicate with the remote service. In particular, the local messaging service retrieves configuration information for a proxy of the shared service that is stored in a globally accessible location, instantiates a copy of the proxy, and sends a message to the proxy to be forwarded to the shared service. Responses from the shared service are returned to the application component via the local messaging service.

### CROSS REFERENCE TO RELATED APPLICATIONS

This application claims the benefit of provisional U.S. patent application Ser. No. 60/173,666 (Attorney Docket No. 243768001US), entitled “SHARED SERVICE FUNCTIONALITY INVOCATION” and filed Dec. 30, 1999, and claims the benefit of provisional U.S. patent application Ser. No. 60/173,712 (Attorney Docket No. 243768011US), entitled “OMNIBUS” and filed Dec. 30, 1999, both of which are hereby incorporated by reference in their entirety.

### TECHNICAL FIELD

The described technology relates generally to the organization of application programs, and more particularly to inter-communication between multiple application programs or portions of application programs.

### BACKGROUND

Many companies are now allowing their customers and/or their business partners to remotely access the company's computer systems. Such companies believe that the providing of this access will give the company an advantage over their competitors. For example, they may believe that a customer will be more likely to order from a company that provides computer systems through which that customer can submit and track their orders. The applications that execute on these computer systems may have been specifically developed to provide information or services that the customers can remotely access, or the applications may have instead been used internally by the companies and are now being made available to the customers. For example, a company may have previously used an application internally to identify an optimum configuration for equipment that is to be delivered to a particular customer's site. By making such an application available to the customer, the customer is able to identify the optimum configuration themselves based on their current requirements, which may not even be known to the company. The rapid growth of the Internet and its ease of use has helped to spur making such remote access available to customers.

Because of the substantial benefits from providing such remote access, companies often find that various groups within the company undertake independent efforts to provide their customers with access to their applications. As a result, a company may find that these groups may have used very different and incompatible solutions to provide remote access to the customers. It is well-known that the cost of maintaining applications over their lifetime can greatly exceed the initial cost of developing the application. Moreover, the cost of maintaining applications that are developed by different groups that use incompatible solutions can be much higher than if compatible solutions are used. Part of the higher cost results from the need to have expertise available for each solution. In addition, the design of the applications also has a significant impact on the overall cost of maintaining an application. Some designs lend themselves to easy and cost effective maintenance, whereas other designs require much more costly maintenance. It would be desirable to have an application architecture that would allow for the rapid development of new applications and rapid adaptation of legacy applications that are made available to customers, that would provide the flexibility needed by a group to provide applications tailored to their customers, and that would help reduce the cost of developing and maintaining the applications.

In addition to communicating with external computers and applications (such as those of customers or suppliers), a company's various applications may also need to communicate with each other. Various problems can arise with such inter-communication, however, such as when different groups within a company used independent efforts to develop their different applications. For example, each application often stores information internally in data structures unique to that application, and thus cannot easily exchange such information because other applications will not understand the format and structure of the data structures. In addition, different applications will often be written in different high-level languages, and will use different protocols for transmission of information. Such differences are exacerbated when applications are developed at different times (e.g., legacy programs) or by different entities.

### BRIEF DESCRIPTION OF THE DRAWINGS

FIG. 1 is a block diagram illustrating uses of an application architecture in one embodiment.

FIG. 2 is a block diagram illustrating an overview of an application framework of the application architecture.

FIG. 3 is a block diagram illustrating the architecture of the application framework.

FIG. 4 is a block diagram illustrating message translation of the application architecture.

FIG. 5 is a block diagram illustrating the processing of a request for functionality that is received from a client system.

FIG. 6 is a diagram illustrating the processing of a request message that is sent from a client system to a container adapter.

FIG. 7 is a block diagram illustrating action components of an action layer of an application program.

FIG. 8 is a block diagram illustrating the processing of a request message by the action layer.

FIG. 9 is a block diagram illustrating the dynamic dispatching of an action.

FIG. 10 is a block diagram illustrating the view components of a view layer of the application program.

FIG. 11 is a block diagram illustrating the processing of a view request object by a view handler.

FIG. 12 is a block diagram illustrating a configuration state architecture for an application program.

FIG. 13 is a block diagram illustrating the organization of a configuration file of an application program.

FIG. 14 is a block diagram illustrating the layout of an action table of the application framework.

FIG. 15 is a block diagram of the layout of a translation table of the application framework.

FIG. 16 is a block diagram illustrating the layout of a view table of the application framework.

FIG. 17 is a flow diagram illustrating the initialization of an application program by a container adapter.

FIG. 18 is a flow diagram of the get-instance method of an application manager factory object.

FIG. 19 is a flow diagram of the processing of a load-components function.

FIG. 20 is a flow diagram of the processing of a load-view-components function.

FIG. 21 is a flow diagram of the processing of a load-action-components function.

FIG. 22 is a flow diagram of the processing of a load-translation-components function.

FIG. 23 is a flow diagram of the processing of the service method of an application service manager object.

FIG. 24 is a flow diagram illustrating the processing of the service method of an action handler.

FIG. 25 is a block diagram illustrating the architecture of a service framework in one embodiment.

FIG. 26 is a block diagram further illustrating the architecture of the service framework.

FIG. 27 is a block diagram illustrating the configuring of the service framework.

FIG. 28 is a block diagram illustrating a service table in one embodiment.

FIG. 29 is a flow diagram illustrating the processing of the register-service method of the service manager object in one embodiment.

FIG. 30 is a flow diagram illustrating the processing of the create-service method in one embodiment.

FIG. 31 is a flow diagram of the lookup method of an environmental context object.

FIG. 32 is a block diagram illustrating invocation of a serialization service.

FIG. 33 is a block diagram illustrating the architecture of the serialization service in one embodiment.

FIG. 34 is a flow diagram illustrating the initialize method of the serialization service in one embodiment.

FIG. 35 is a flow diagram illustrating the processing of the decode-to-Java method of a translator in one embodiment.

FIG. 36 is a flow diagram illustrating the processing of the read-object method of the serialization service in one embodiment.

FIG. 37 is a block diagram illustrating the architecture of the configuration service in one embodiment.

FIG. 38 is a flow diagram illustrating a get-configuration-as-objects method of the configuration service in one embodiment.

FIG. 39 is a block diagram illustrating an embodiment of a variety of components communicating and transferring information, including a messaging component that facilitates the communication and information transfer.

FIG. 40 is a block diagram illustrating a computer system capable of executing one or more shared service server components and/or client components.

FIG. 41 is a block diagram illustrating an embodiment of a messaging component that is processing a message sent from a client.

FIG. 42 is a flow diagram of an embodiment of the Shared Service Registration routine.

FIG. 43 is a flow diagram of an embodiment of the Messaging Component routine.

FIGS. 44A and 44B are a flow diagram of an embodiment of the Generic Transport Connector routine.

FIG. 45 is a flow diagram of an embodiment of the PassThru Component routine.

FIG. 46A represents a directory hierarchy.

FIG. 46B is a block diagram illustrating the directory compiler.

FIG. 47 is a block diagram illustrating an LDAP schema and LDAP directory entries.

FIG. 48 is a block diagram illustrating the objects generated to access an LDAP directory.

FIG. 49 is a block diagram illustrating components of the interface system in this alternate embodiment.

FIG. 50 is a block diagram illustrating objects of instantiated during runtime of an application program.

FIG. 51 is a flow diagram of the lookup method of any directory manager object in one embodiment.

FIG. 52 is a flow diagram illustrating an application program using a proxy object.

FIG. 53 is a flow diagram illustrating a method of a proxy object in one embodiment.

### DETAILED DESCRIPTION

An application architecture for developing applications for a computer system is provided such that modules within an application can inter-communicate and such that multiple applications can inter-communicate. In one embodiment, the application architecture includes an application framework and applications. Each application can include action handlers and view handlers. The action handlers implement the business logic of the application, and the view handlers control the formatting of the results returned by the business logic. The application framework receives requests for services or functionality from client computers (e.g., customer computers), identifies the action handlers that can service the requests, invokes the identified action handlers to service the requests to generate responses, identifies view handlers for formatting the responses, and invokes identified view handlers to format and send the responses to the client computers. The action handlers may also indicate a presentation view that specifies the way in which the responses are to be presented to the client systems. For example, a presentation view may indicate that a response is to be displayed in accordance with the layout of a certain web page. The applications may also include translators for translating requests into a format that is suitable for processing by the action handlers. For example, a client computer may provide requests using an HTTP protocol or in an HTML format, whereas an action handler may be developed to process requests using the XML format or protocol. In such a case, a translator would translate the requests from the protocol used by the client to the protocol used by the action handler. The use of translators allows the applications to be developed independently of the protocols used by the client computers. In addition, new protocols that are used by client computers can be accommodated by developing additional translators without the need to modify the action handlers that implement the business logic.

In one embodiment, the application architecture also provides a service framework through which an application can access services common to other applications in a way that is independent of the container (e.g., operating environment) in which the application framework executes. The service framework loads service components as indicated by configuration information, which includes the names and implementations of the services. The service framework provides an interface through which an application can retrieve references to the implementations of the various services. To retrieve an implementation, the application (e.g., an action handler or view handler) provides the name of the desired service to the service framework. The service framework then looks up the implementation for the service of that name, and returns to the application a reference to the implementation. The application can then use the reference to directly invoke the implementation of that service.

In one embodiment, the application architecture allows the applications to be loaded based on information stored in configuration files. The information in the configuration files may define the translators, action handlers, and view handlers of an application. The configuration information may specify the types of requests that may be received by the application and specify the action handler that is to service each request. The configuration information may also specify what translators should be used to convert a request from a protocol used by a client computer to a protocol used by an action handler. In addition, the configuration information may be hierarchically organized. That is, some configuration information may be global to all applications that use the application architecture, and other configuration information may be specific to one or more particular applications. Configuration information that is specific to a particular application would, in general, override configuration information that is global to all applications.

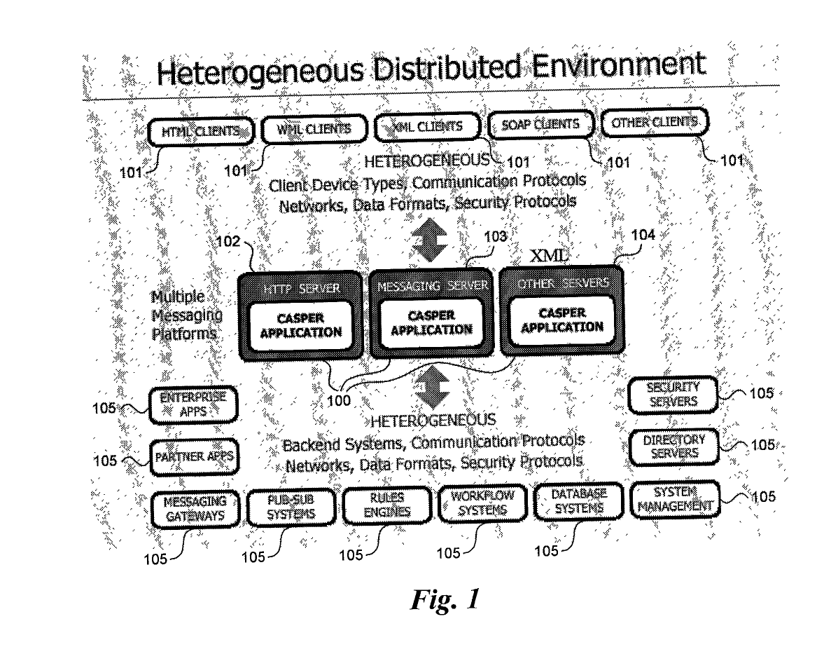

FIG. 1 is a block diagram illustrating uses of the application architecture in one embodiment. The application architecture allows an application program to provide its services to various client systems 101 that use differing communication protocols and data formats. For example, one client system may communicate with the application program using the HTML format, and another client system may communicate with the application program using the XML format. The application architecture facilitates the development of application programs whose business logic is independent of the protocol used by the client systems. The application programs 100 implement such business logic, and interact with the client systems through various servers such as HTTP server 102, messaging server 103, and XML server 104. The application architecture also facilitates the development of application programs that use various services 105, such as legacy applications and database systems. In particular, the application architecture defines an interface through which the application programs can access these services.

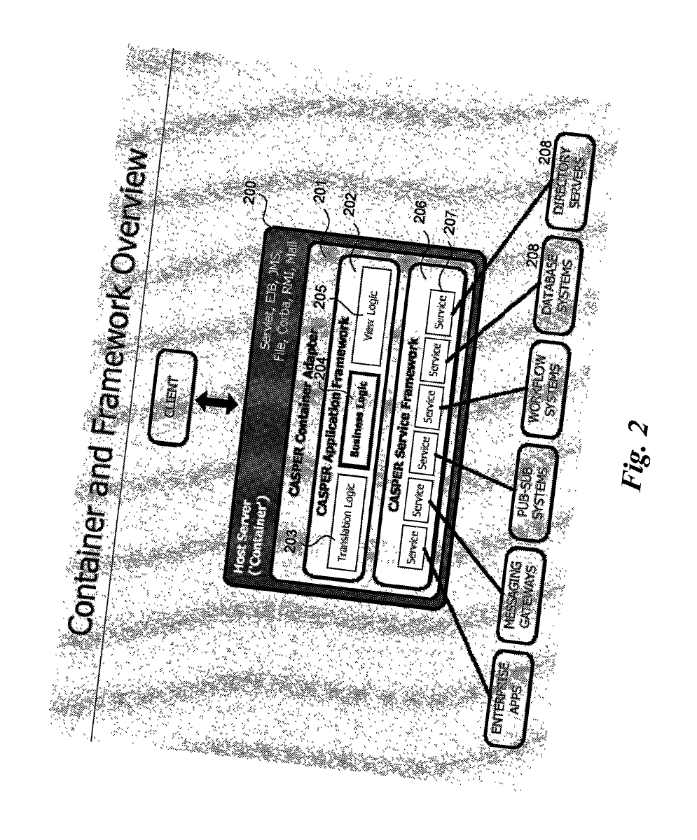

FIG. 2 is a block diagram illustrating an overview of the application framework of the application architecture. The application programs execute in a container environment 200, such as a Common Object Request Broker Architecture (“CORBA”) environment or Java's remote messaging invocation (“RMI”) environment. The application architecture specifies that container adapters 201 serve as an interface between the various container types and an application framework 202. That is, a different implementation of a container adapter is used for each possible container type, and in this way the application programs can be independent of the type of container. In particular, the application framework defines the interface between the container adapter and the application program. The application architecture specifies that an application program is divided into translation logic 203, business logic 204, and view logic 205. The business logic receives requests for services or functionality in an application-specific format, services the requests, and provides responses to the requests in an application-specific format. The translation logic is responsible for translating the requests received from a client system in a client-specific format into the application-specific format defined for the business logic. The view logic is responsible for generating and sending a response that is in the client-specific format using the view and response specified by the business logic. The translation logic, business logic, and view logic may use the services of the service framework 206 to implement their functionality. The service framework defines a common interface that the application programs can use to access various services 208 such as database systems and directory servers.

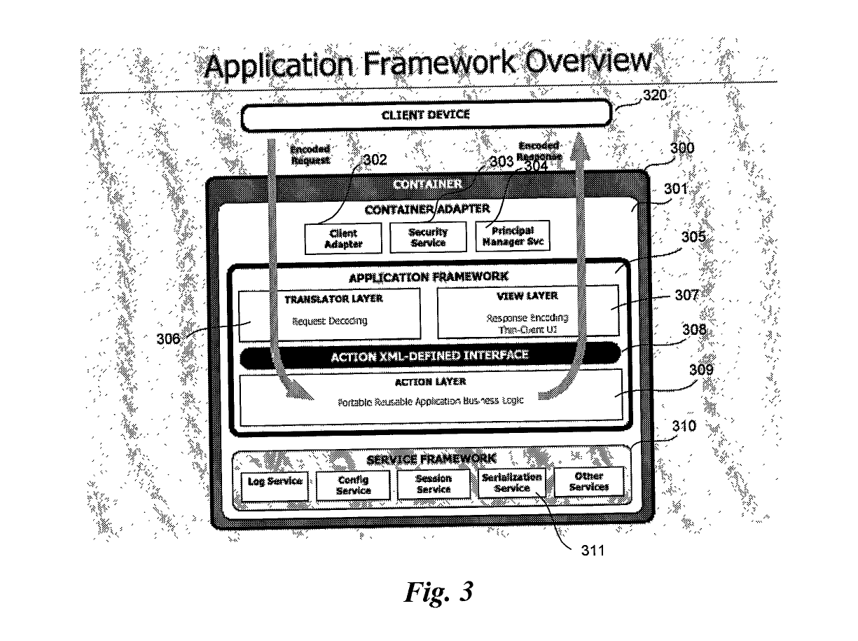

FIG. 3 is a block diagram illustrating the architecture of the application framework. A client system 320 requests services of an application program by sending request messages in a client-specific format to the application program, and receives results of the services in response messages in a client-specific format. A container 300 receives the request messages and forwards them to container adapter 301, and receives response messages from the container adapter and forwards them to the client system. The container adapter includes a client adapter component 302, a security service component 303, and the principal manager service 304. The application framework includes a translation layer 306, a view layer 307, and an action layer 309. In the illustrated embodiment, the action layer, view layer and translation layer inter-communicate via defined interfaces 308 using XML-based messages. The action layer, view layer, and translation layer may also invoke the services of the service framework 310, such as serialization service 311. The translation layer translates request messages received in the client-specific format into the application format, and the view layer converts response messages in the application-specific format into the client-specific format.

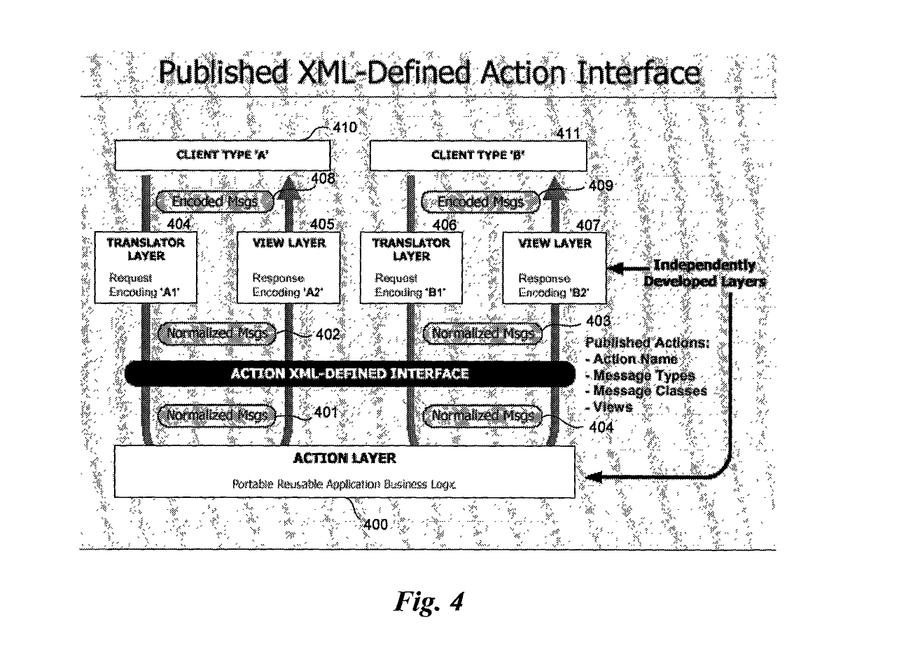

FIG. 4 is a block diagram illustrating the message translation of the application architecture. The client systems 410 and 411 are developed to use the business logic provided by action layer 400. Each client system, however, may use a different client-specific messaging protocol to communicate with the business logic. A message in a client-specific format is also referred to as an “encoded message,” and a message in an application-specific format is also referred to as a “normalized message” that has a specific message type. When the translation layer 404 receives a request message from the client system 410, it translates the request message into the application-specific format. In one embodiment, the application architecture defines two normalized formats for the application-specific format. One normalized format is an XML-based format and the other normalized format uses an object (e.g., a Java object) through which attributes of the message can be retrieved. The action layer inputs a request message in a normalized format, performs its business logic, and outputs a response message in a normalized format. The view layer 405 is then responsible for converting the response message from the normalized format to the client-specific format 408. The processing of request messages from client system 411 is similar to the processing of request messages from client system 410, except that the client-specific formats of the request and response messages may be different.

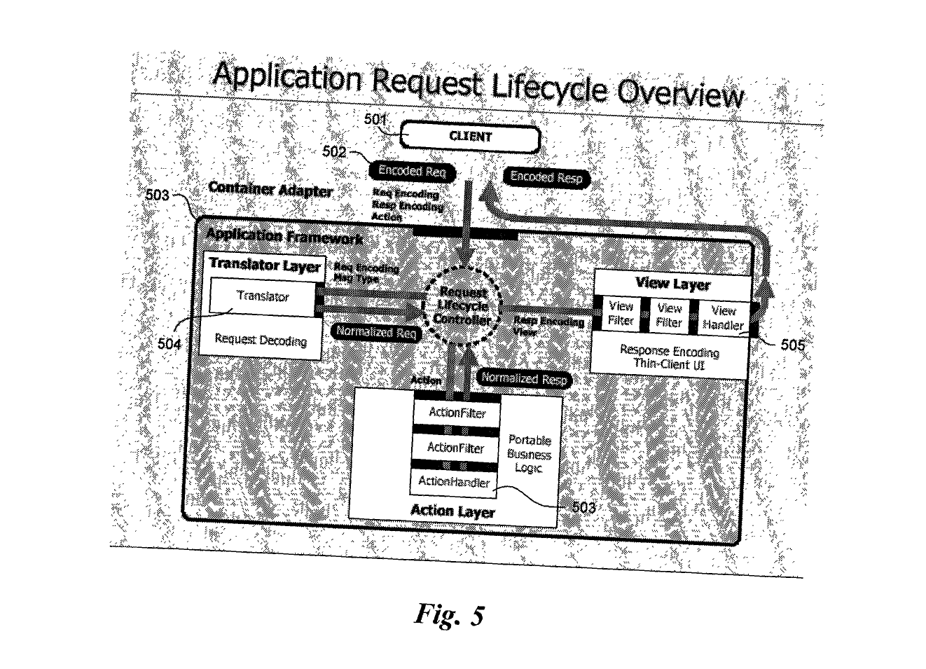

FIG. 5 is a block diagram illustrating the processing of a request message that is received from a client system. The client system 501 sends a request message 502 in the client format. The request message specifies the client format for the response message and the action to be performed by the application program. When the application program is loaded, it registers with the application framework its components that implement the translation layer, action layer, and view layer. In one embodiment, the action layer includes an action handler for each action that is serviced by the application. Similarly, the view layer may include multiple view handlers, and the translation layer may use multiple translators. When the application framework 503 receives a request message, it identifies which action handler is responsible for servicing the action of the request message. The application framework may also identify a translator 504 that can translate the request message from the client format to the application format needed by the identified action handler. The application framework then forwards the request message to the action handler. The action handler uses the translator to translate that request message to the appropriate normalized format. The action handler performs its business logic and supplies its response message in the appropriate normalized format to the application framework. The application framework then forwards the response message and view specified by the action handler to the view handler 505 that is responsible for generating and sending the response message to the client system. Each action handler and view handler may also have associated filters for preprocessing and postprocessing of the request and response messages. For example, a filter of an action handler may be responsible for logging each request message and response message.

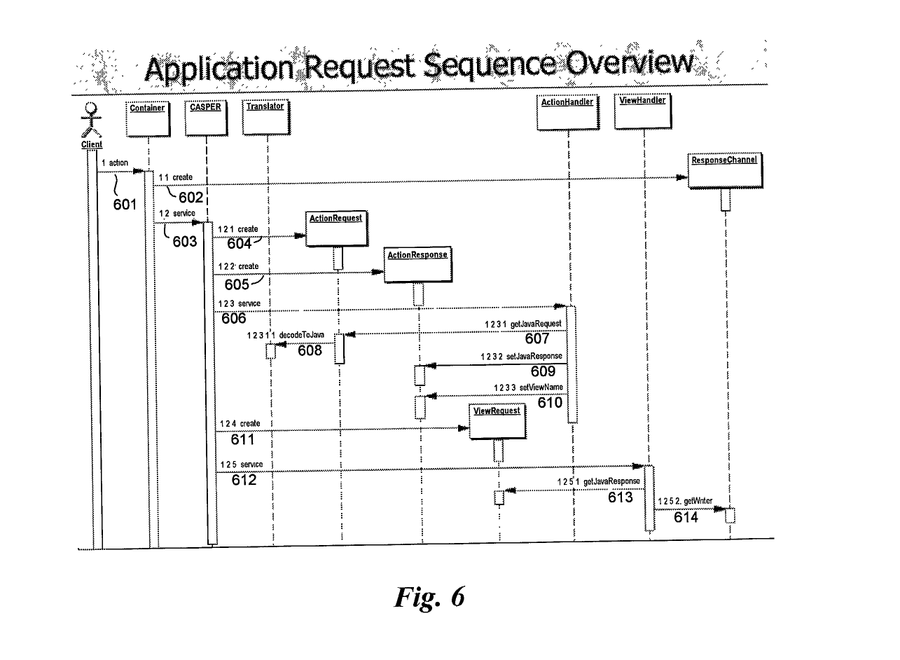

FIG. 6 is a diagram illustrating the processing of a request message that is sent from a client system to a container adapter. The client system initially sends 601 a request message that specifies an action to be performed by the application program and the client format of the response message. When the container adapter receives the request message, it creates 602 a response channel object with which the application program will transmit the response message to the client system. In particular, the response channel object includes sufficient information (e.g., an address of the client system) so that the response message can be sent to the client system. The container adapter then requests 603 the application framework to service the request message, passing both the response channel object and the request message.

The application framework creates 604 an action request object through which the request message can be accessed in either normalized format. The application framework also creates 605 an action response object for holding the response message of the application program. The application framework then identifies the action handler that can service the requested action and the translator for translating the request message in the client format to the normalized format needed by the identified action handler, and stores an indication of that translator in the action request object. The application framework then requests 606 the action handler to perform that action, passing to the action handler the response channel object, action request object, and action response object.

To process the message, the action handler requests 607 the action request object to convert the request message to the normalized format. The action request object in turn requests 608 the translator to convert the request message to the normalized format. After receiving the request message in the normalized format, the action handler then performs its business logic. When the action handler completes performance of its business logic, it stores 609 the response message in the action response object and stores 610 an indication of the type of view for the response in the action response object. The action handler then returns to the application framework.

The application framework creates 611 a view request object that identifies the view type, the response message, and the client format for the response message. The application framework then identifies the view handler for processing of the view request, and requests 612 the identified view handler to service the view request. The application framework passes the view request object, the action request object, and the response channel object to the view handler. The view handler then retrieves the view from the view request object, and retrieves 613 the response message from the action response object. The view handler converts the response message from the normalized format to the client format in accordance with the view. The view handler then uses the response channel object to send 614 the response message to the client system.

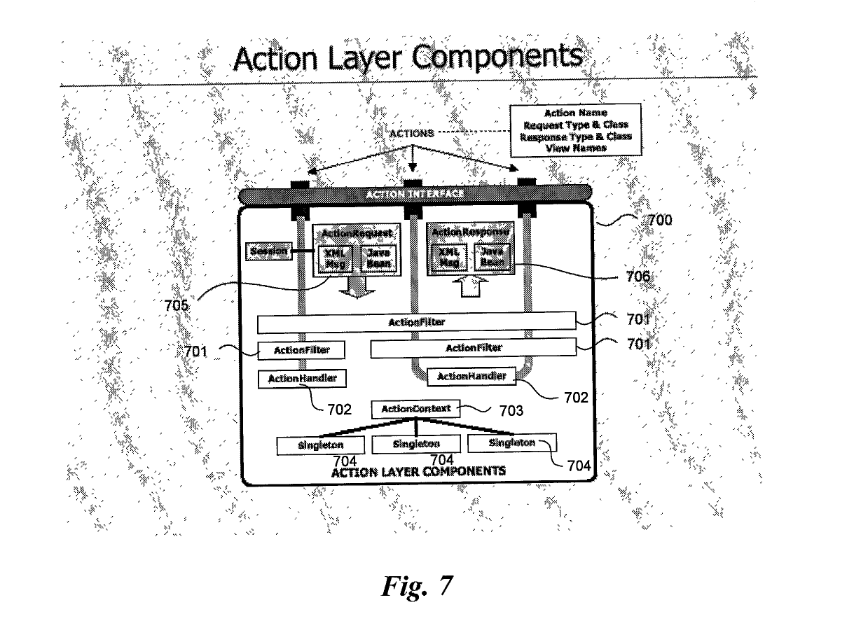

FIG. 7 is a block diagram illustrating action components of the action layer of an application program. The action components may include various action filters 701 that perform preprocessing of a request message and postprocessing of a response message for an action handler. The action components also include various action handlers 702. The action filters and action handlers may use the services of an action context object 703 that provides context information that is common to the action components of the action layer. The action context object provides access to common information such as configuration information and parameters, which may be represented by singleton objects 704. (A singleton object is the only object that is instantiated for a particular class.) The action request object 705 and the action response object 706 provide access to the response and request messages in a normalized format. In one embodiment, two normalized formats are provided: an XML-based format and a JavaBean-based format.

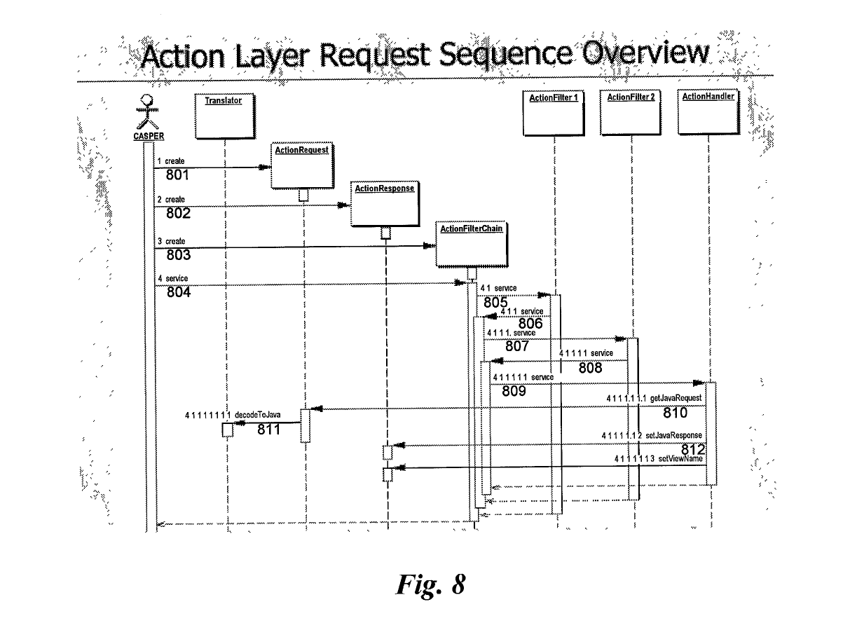

FIG. 8 is a block diagram illustrating the processing of a request message by the action layer. As discussed above, when the application framework receives a request message, it creates 801 an action request object and creates 802 an action response object. The application framework then identifies the action handler that is to process the request message, and creates 803 an application filter chain object for the application handler. The action filter chain object controls the invocation of each of the filters in sequence followed by invocation of the action handler. The application framework requests 804 the action filter chain object to service the message request, and the action filter chain object then requests 805 the first action filter to service the request. The first action filter performs its preprocessing of the request message and recursively requests 806 the action filter chain object to continue servicing the request message. The action filter chain object then requests 807 the second action filter object to service the message request. The second action filter performs its preprocessing of the request message and then recursively requests 808 the action filter chain to continue servicing the request message. This invoking of action filters continues until the last action filter is invoked. The action filter chain object then requests 809 the action handler to service the request message.

The action handler then requests 810 the action request object to translate the request message from the client format to the normalized format. The action request object requests 811 the translator to perform the translation. The action handler then performs its business logic on the translated request message. The action handler then stores 812 the response message in the normalized format and 813 the view in the action response object. The action handler then returns to the action filter chain object, which returns controls to the second action filter for performing its postprocessing of the response message. The second action filter returns to the action filter chain object, which returns to the first action filter for performing its postprocessing of the response message. The first action filter then returns to the action filter chain object, which returns to the application framework to complete the processing.

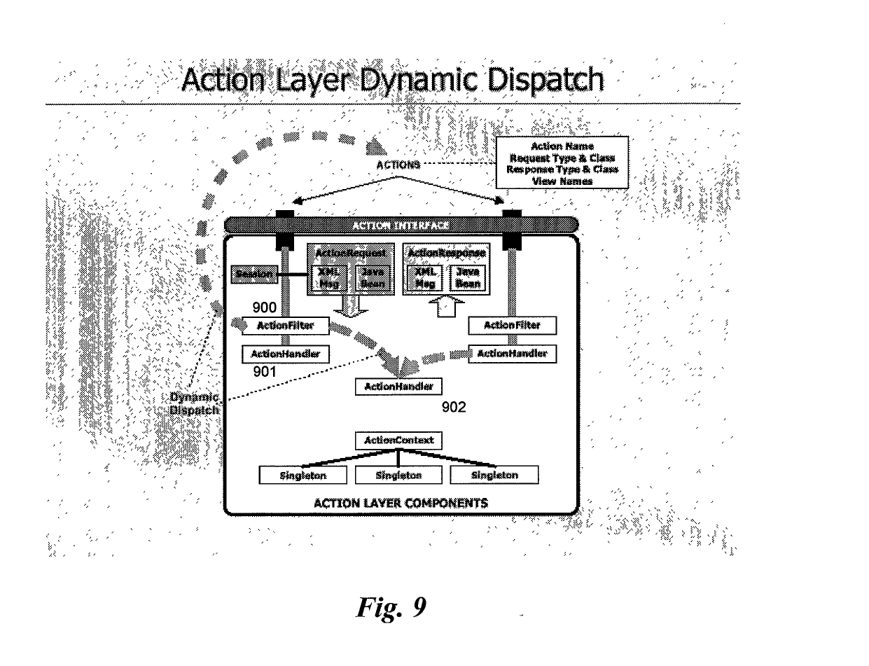

FIG. 9 is a block diagram illustrating the dynamic dispatching of an action. Dynamic dispatching refers to the process in which one action component requests an action handler to perform some action on its behalf. In one embodiment, an action handler or an action filter can dynamically dispatch actions to an action handler. Action handler 901 may have been originally designed to process a request for a certain action. If action filter 900 is later installed, then that action filter may receive the message request and dynamically dispatch it to a different action handler, such as action handler 902. The action filter can dispatch the request message to action handler 902 either by invoking action handler 902 directly or by sending the request message with a different action to the application framework for processing.

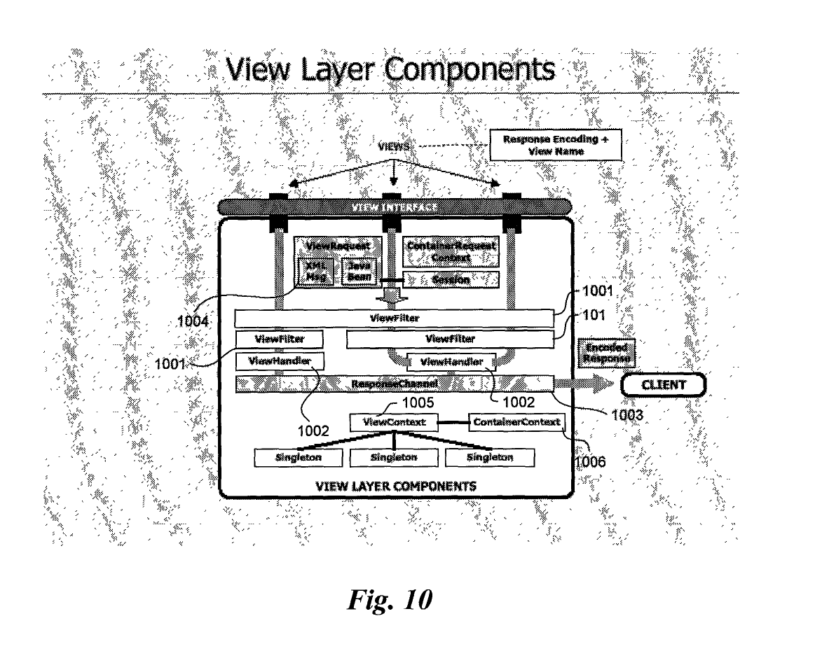

FIG. 10 is a block diagram illustrating the view components of the view layer. The view components include view filters 1001 and view handlers 1002. The view components also include response channel object 1003 that is passed to the application framework by the container adapter. The view components access the response message using the view request object 1004. When the view handler is invoked, it is passed a view request message that is processed by the view filters (if any) first. The view handler then uses the response channel object to forward the request message in the client format to the client system. The view components may also include a view context object 1005 through which the view components can access information that is common to the view layer. The view context object may also provide access to a container context 1006 that provides access to information relating to the container.

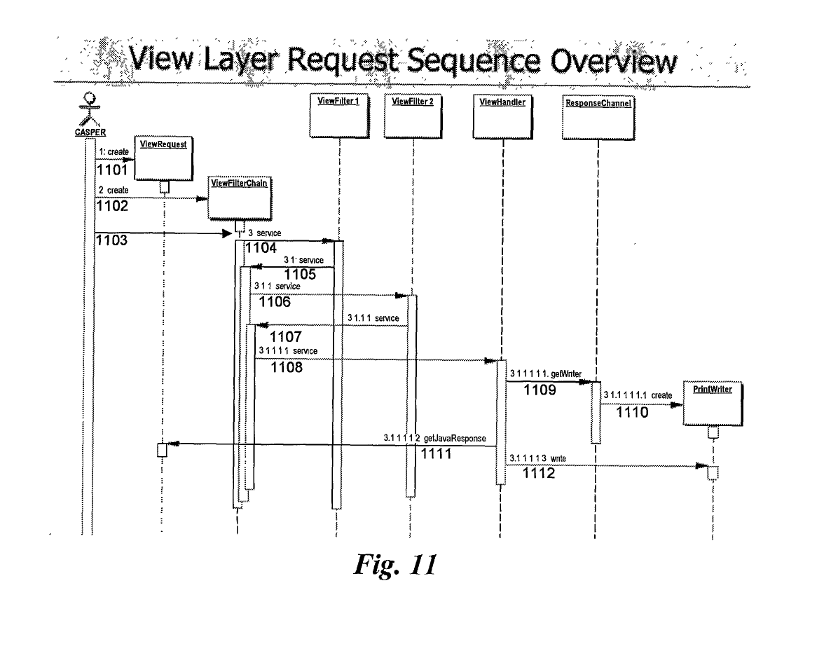

FIG. 11 is a block diagram illustrating the processing of a view request object by a view handler. When the application framework receives a response message from the action layer, it creates 1101 a view request object. The application framework then identifies the view handler that is to process the response message, and creates 1102 a view filter chain object for controlling the invocation of the filters and the view handler. The application framework requests 1103 the view filter chain object to service the view request message. The view filter chain object then requests 1104 the first view filter to service the view request object. The first view filter performs its preprocessing and recursively requests 1105 the view filter chain object to service the view request object. The view filter chain object then requests 1106 the second view filter to process the view request message. The second view filter then performs its preprocessing of the view request message and recursively requests 1107 the view filter chain object to service the view message request. This invoking of view filters continues until the last view filter is invoked. The view filter chain object then requests 1108 the view handler to service the view request object.

The view handler then requests 1109 the response channel object to provide a print writer object. The response channel object creates 1110 the print writer object and returns a reference to the print writer object. The view handler then retrieves 1111 the response message, view, and client format for the response message from the view request object, prepares the response message in accordance with the view, and sends 1112 the response message to the client system using the print writer object. The view handler then returns to the view filter chain object, which returns to the second view filter which performs its postprocessing and then returns to the view filter chain object. The view filter chain object then returns to the first view filter, which performs its postprocessing and then returns to the view filter chain object. The view filter chain object then returns to the application framework to complete the processing.

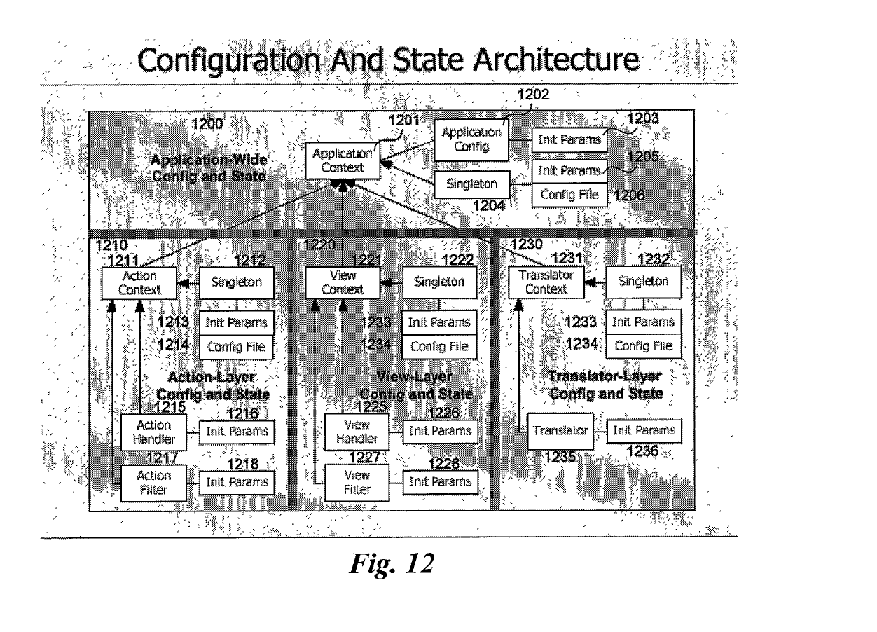

FIG. 12 is a block diagram illustrating the configuration and state architecture for an application program. The application program contains application-wide configuration and state information 1200, action layer configuration and state information 1210, view layer configuration state information 1220, and translation layer configuration and state information 1230. The application-wide configuration and state information is represented by application context object 1201 that provides access to an application configuration object 1202 and various singleton objects 1204. The application configuration object provides access to configuration information that specifies initialization parameters 1203 of the application program, and the singleton objects provide access to initialization parameters 1205 and configuration file information 1206. The action layer, view layer, and translation layer each have access to the application context object. In addition, the action layer includes configuration and state information that is common to all the action components. The action context object 1211 provides access to various singleton objects 1212 that each may provide access to initialization parameters 1213 and configuration file information 1214 for the action layer. The action context object also provides access to the action handlers 1215 and the action filter 1217. The action handlers have access to initialization parameters 1216, and the action filters have access to initialization parameters 1218. The view layer includes configuration and state information that is common to all view components, and the translation layer includes configuration and state information that is common to all translators. The organization of the configuration and state information of the view and translation layers is similar to that of the action layer except that filters are not defined for translators.

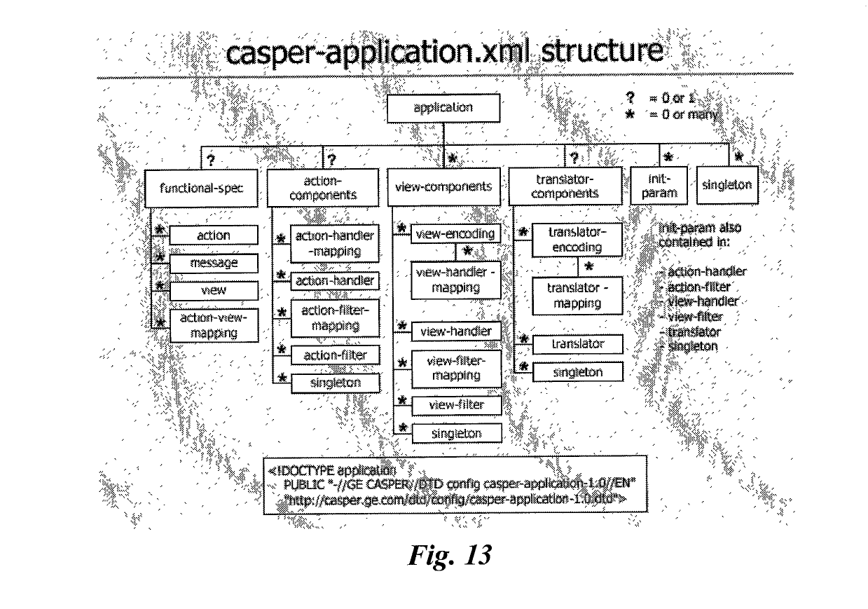

FIG. 13 is a block diagram illustrating the organization of a configuration file of an application program in one embodiment. The configuration file includes a functional specification section, an action components section, a view components section, a translation components section, an initialization parameters section, and a singleton section. The functional specification section defines the actions, messages, views, and action-to-view mappings used by the application program. The action components section defines action handler mappings, action handlers, action filter mappings, action filters, and singletons. The view components section defines the view encodings and view handler mappings, view handlers, view filter mappings, view filters, and singletons. The translator component section defines the translator encoding and translator mappings, translators, and singletons.

| | |
|---|---|
| 1 | <?xml version=“1.0” encoding=“ISO-8859-1”?> |
| 2 | <!DOCTYPE application |
| 3 | PUBLIC “-//GE CASPER//DTD config casper-application-1.0//EN” |
| 4 | “http://casper.ge.com/dtd/config/casper-application-1.0.dtd”> |
| 5 | <application |

| | |
|---|---|
| 6 | name=“sample-app03” |
| 7 | description=“Sample Application 3” |
| 8 | msg-serialization-service=“sfo-xml-serialization”> |
| 9 | <!−− |
| 10 | ============================================================ |
| 11 | FUNCTIONAL SPECIFICATION |
| 12 | ============================================================ |
| 13 | −−> |
| 14 | <functional-spec> |

| | |
|---|---|
| 15 | <!−− Actions −−> |
| 16 | <action name=“get-cart” |
| 17 | rsp-type=“cart-contents-rsp”/> |
| 18 | <action name=“get-catalog” |
| 19 | rsp-type=“catalog-contents-rsp”/> |
| 20 | <action name=“get-product” |
| 21 | req-type=“get-product-req” rsp-type=“product-description-rsp”/> |
| 22 | <action name=“add-product” |
| 23 | req-type=“add-product-req” rsp-type=“update-cart-rsp”/> |
| 24 | <action name=“del-product” |
| 25 | req-type=“del-product-req” rsp-type=“update-cart-rsp”/> |
| 26 | <action name“NULL”/> |
| 27 | |
| 28 | <!−− Views −−> |
| 29 | <view name=“cart-view”/> |
| 30 | <view name=“catalog-view”/> |
| 31 | <view name=“product-view”/> |
| 32 | <view name=“cart-updated-view”/> |
| 33 | <view name=“welcome-view”/> |
| 34 | |
| 35 | <!−− Action-View-Mappings −−> |
| 36 | <action-view-mapping action=“get-cart”> |
| 37 | <view name=“cart-view”/> |
| 38 | </action-view-mapping> |
| 39 | <action-view-mapping action=“get-catalog”> |
| 40 | <view name=“catalog-view”/> |
| 41 | </action-view-mapping> |
| 42 | <action-view-mapping action=“get-product”> |
| 43 | <view name=“product-view”/> |
| 44 | </action-view-mapping> |
| 45 | <action-view-mapping action=“add-product”> |
| 46 | <view name=“cart-updated-view”/> |
| 47 | </action-view-mapping> |
| 48 | <action-view-mapping action=“del-product”> |
| 49 | <view name=“cart-updated-view”/> |
| 50 | </action-view-mapping> |
| 51 | <action-view-mapping action=“NULL”> |
| 52 | <view name=“welcome-view”/> |
| 53 | </action-view-mapping> |

| | |
|---|---|
| 54 | </functional-spec> |
| 55 | <!−− |
| 56 | ============================================================ |
| 57 | ACTION COMPONENT CONFIGURATION |
| 58 | ============================================================ |
| 59 | −−> |
| 60 | <action-components> |

| | |
|---|---|
| 61 | <!−− Action Handler Mappings −−> |
| 62 | <action-handler-mapping |
| 63 | action=“get-cart” class-name=“sample.app03.action.GetCart”/> |
| 64 | <action-handler-mapping |
| 65 | action=“get-catalog” class-name=“sample.app03.action.GetCatalog”/> |
| 66 | <action-handler-mapping |
| 67 | action=“get-product” class-name=“sample.app03.action.GetProduct”/> |
| 68 | <action-handler-mapping |
| 69 | action=“add-product” class-name=“sample.app03.action.AddProduct”/> |
| 70 | <action-handler-mapping |
| 71 | action=“del-product” class-name=“sample.app03.action.DelProduct”/> |
| 72 | <action-handler-mapping |
| 73 | action=“NULL” handler=“null-handler”/> |
| 74 | |
| 75 | <!−− Action Handlers −−> |
| 76 | |
| 77 | <action-handler name=“null-handler” |
| 78 | class-name=“sample.app03.action.NullActionHandler”> |
| 79 | <init-param name=“view” value=“welcome-view”/> |
| 80 | </action-handler> |
| 81 | <!−− Action Filter Mappings −−> |
| 82 | <action-filter-mapping action=“*”> |
| 83 | <action-filter-ref class-name=“sample.app03.action.LogFilter”/> |
| 84 | <action-filter-ref class-name=“sample.app03.action.AuditFilter”/> |
| 85 | </action-filter-mapping> |
| 86 | |
| 87 | <!−− Action Singletons −−> |
| 88 | |
| 89 | <singleton |
| 90 | class-name=“sample.app03.action.SharedActionResources” |
| 91 | config=“product-catalog.xml” |
| 92 | config-serialization-service=“sfo-xml-serialization”> |

| | |
|---|---|
| 93 | </singleton> |
| 94 | </action-components> |
| 95 | <!−− |
| 96 | ============================================================ |
| 97 | VIEW COMPONENT CONFIGURATION |
| 98 | ============================================================ |
| 99 | −−> |
| 100 | <!−− |

=============================================================

| | |
|---|---|
| 101 | Portable View Components |
| 102 | −−> |
| 103 | <view-components> |

| | |
|---|---|
| 104 | <!−− View Handler Mappings −−> |
| 105 | <view-encoding encoding=“html”> |

| | |
|---|---|
| 106 | <view-handler-mapping |
| 107 | view=“$java.lang.Exception” |
| 108 | class-name=“sample.app03.view.SystemErrorView”/> |
| 109 | <view-handler-mapping |
| 110 | view=“$com.ge.casper.app.translator.TranslationException” |
| 111 | class-name=“sample.app03.view.TranslationErrorView”/> |

| | |
|---|---|
| 112 | </view-encoding> |
| 113 | <!−− Singletons −−> |
| 114 | |
| 115 | <singleton |
| 116 | class-name=“sample.app03.view.SharedViewResources”> |
| 117 | <init-param name=“foo” value=“bar”/> |
| 118 | </singleton> |

| | |
|---|---|
| 119 | </view-components> |
| 120 | <!−− |

=============================================================

| | |
|---|---|
| 121 | http-servlet View Components |
| 122 | −−> |
| 123 | <view-components container-type=“http-servlet”> |

| | |
|---|---|
| 124 | <!−− View Handler Mappings −−> |
| 125 | <view-encoding encoding=“html”> |

| | |
|---|---|
| 126 | <view-handler-mapping |
| 127 | view=“cart-view” handler=“html-cart-view”/> |
| 128 | <view-handler-mapping |
| 129 | view=“cart-updated-view” handler=“html-cart-updated-view”/> |
| 130 | <view-handler-mapping |
| 131 | view=“catalog-view” handler=“html-catalog-view”/> |
| 132 | <view-handler-mapping |
| 133 | view=“product-view” handler=“html-product-view”/> |
| 134 | <view-handler-mapping |
| 135 | view=“welcome-view” handler=“html-welcome-view”/> |

| | |
|---|---|
| 136 | </view-encoding> |
| 137 | <!−− ViewHandlers −−> |
| 138 | <view-handler |
| 139 | name=“html-cart-view” |
| 140 | class-name=“sample.app03.view.jsp.CartJspPreparer”> |
| 141 | <init-param name=“jsp” value=”/html/cart-view.jsp”/> |
| 142 | </view-handler> |
| 143 | <view-handler |
| 144 | name=“html-cart-updated-view” |
| 145 | class-name=“sample.app03.view.http.HttpRedirector”> |
| 146 | <init-param name=“action” value=“get-cart”/> |
| 147 | </view-handler> |
| 148 | <view-handler |
| 149 | name=“html-catalog-view” |
| 150 | class-name=“sample.app03.view.jsp.CatalogJspPreparer”> |
| 151 | <init-param name=“jsp” value=”/html/catalog-view.jsp”/> |
| 152 | </view-handler> |
| 153 | <view-handler |
| 154 | name=“html-product-view” |
| 155 | class-name=“sample.app03.view.jsp.ProductJspPreparer”> |
| 156 | <init-param name=“jsp” value=”/html/product-view.jsp”/> |
| 157 | </view-handler> |
| 158 | <view-handler |
| 159 | name=“html-welcome-view” |
| 160 | class-name=“sample.app03.view.jsp.NoOpJspPreparer”> |
| 161 | <init-param name=“jsp” value=”/html/index.jsp”/> |
| 162 | </view-handler> |
| 163 | <!−− View Filter Mappings −−> |
| 164 | <view-filter-mapping encoding=“*” view=“*”> |
| 165 | <view-filter-ref class-name=“sample.app03.view.LogFilter”/> |
| 166 | <view-filter-ref class-name=“sample.app03.view.AuditFilter”/> |
| 167 | </view-filter-mapping> |
| 168 | |

| | |
|---|---|
| 169 | </view-components> |
| 170 | <!−− |
| 171 | ============================================================ |
| 172 | TRANSLATOR COMPONENT CONFIGURATION |
| 173 | ============================================================ |
| 174 | −−> |
| 175 | <translator-components> |

| | |
|---|---|
| 176 | <!−− Encodings −−> |
| 177 | <translator-encoding encoding=“nvpair”> |

| | |
|---|---|
| 178 | <translator-mapping |
| 179 | message-type=“ANY” |
| 180 | class-name=“sample.app03.translator.NvPairTranslator”/> |

| | |
|---|---|
| 181 | </translator-encoding> |
| 182 | <!−−Singletons −−> |
| 183 | |
| 184 | <singleton |
| 185 | class-name=“sample.app03.translator.SharedTranslatorResources”> |
| 186 | <init-param name=“foo” value=“bar”/> |
| 187 | </singleton> |

| | |
|---|---|
| 188 | </translator-components> |
| 189 | <!−− |
| 190 | ============================================================ |
| 191 | APPLICATION-WIDE INITIALIZATION PARAMETERS |
| 192 | ============================================================ |
| 193 | −−> |
| 194 | <init-param name=“param1” value=“value1”/> |
| 195 | <init-param name=“param2” value=“value2”/> |
| 196 | <!−− |
| 197 | ============================================================ |
| 198 | APPLICATION-WIDE SINGLETONS |
| 199 | ============================================================ |
| 200 | −−> |
| 201 | <singleton |
| 202 | class-name=“sample.app03.AppContextListener”> |
| 203 | <init-param name=“foo” value=“bar”/> |
| 204 | </singleton> |

| | |
|---|---|
| 205 | </application> |

Lines 14-26 specify the actions supported by the application. For example, lines 20 and 21 indicate that a “get-product” action is supported and that its request message type is “get-product-req” and its response message type is “production-description-rsp.” Lines 28-33 specify the views supported by the application. For example, line 31 indicates that one view is named “product-view.” Lines 35-53 specify action-to-view mappings. For example, lines 42-44 indicate that the “get-product” action uses the “product-view.” Lines 60-94 specify the action components. Lines 62-80 specify the implementing class for each action handler. For example, lines 66-67 indicate that the “get-product” action is implemented by the “sample.app03.action.GetProduct” class. Lines 81-85 specify the implementing classes of the action filters and to which actions the filters are to be applied. Line 82 indicates by the “*” that the filters apply to each action. Lines 89-93 specify singletons for the action layer. For example, lines 89-93 indicate that one singleton is specified with an implementing class of “sample.app03.action.SharedActionResources,” with a configuration file of “product-catalog.xml” and with a configuration serialization service of “sfo-xml-serialization.” Lines 103-169 specify the view components of the application. Lines 123-136 specify a client format (e.g., HTML) and the associated views and view handlers. For example, lines 132-133 indicate that the combination of the “html” client format and the “product-view” view are associated with the “html-product-view” handler. Lines 138-162 specify the implementing classes of the view handlers. For example, lines 153-157 indicate that “html-product-view” view has the “sample.app03.viewjsp. ProductJspPreparer” implementing class with a name-value pair initialization parameter of “jsp-/html/product-viewjsp.” Lines 175-188 specify the translator components for the application. For example, lines 177-181 indicate that a message encoding of “nvpair” to any message type uses the translator implemented by the “sample.app03.translator. NvPairTranslator” class.

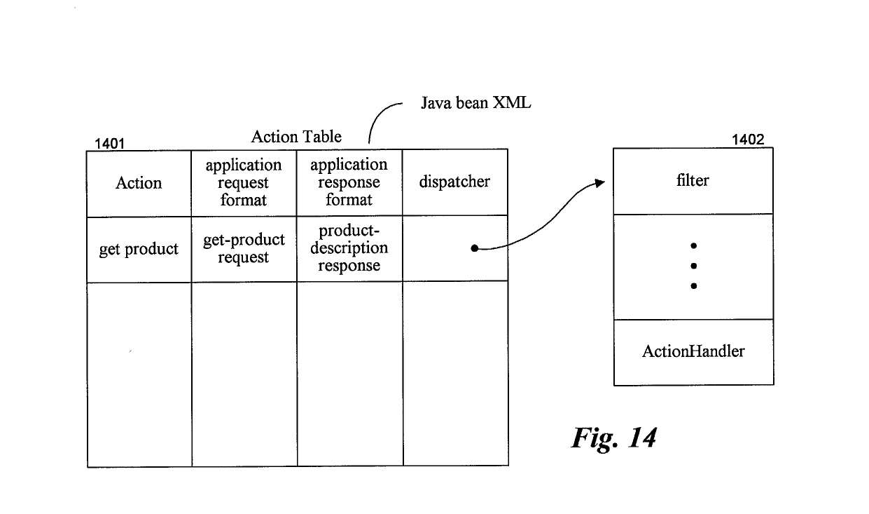

FIG. 14 is a block diagram illustrating the layout of the action table of the application framework. The application framework generates the action table based on the information contained in the configuration file. The action table 1401 contains an entry for each action that is defined in the configuration file. The action table contains the name of the action, the application format of the request message, the application format of the response message, and a reference to the dispatcher for that action handler. For example, the first entry of the action table indicates that the action name is “get-product,” the request format is “get-product-req,” and the response format is “product-description-rsp.” The dispatcher is responsible for invoking the filters in sequence and then the action handler as indicated by the action component table 1402. The configuration file identifies the class of each action filter and handler, and the application manager object instantiates an object of the class for each action filter and handler during initialization and stores a reference to a dispatch method that controls the invoking of the action filters and then the action handler.

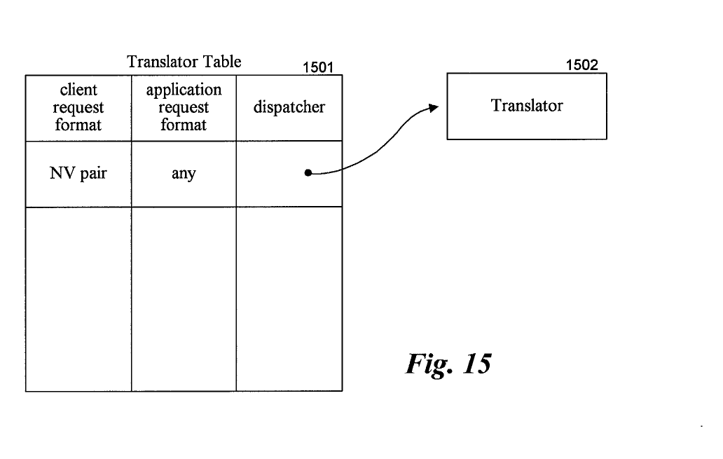

FIG. 15 is a block diagram of the layout of the translation table of the application framework. The application framework generates the translation table based on the information contained in the configuration file. The translation table 1501 contains an entry for each translator that is defined in the configuration. The entries contain the client format of the request message, the application format of the request message, and a dispatcher for the translator 1502. For example, the first entry of the translation table indicates that the client request format is “nvpair” and that the application request format is “any.”

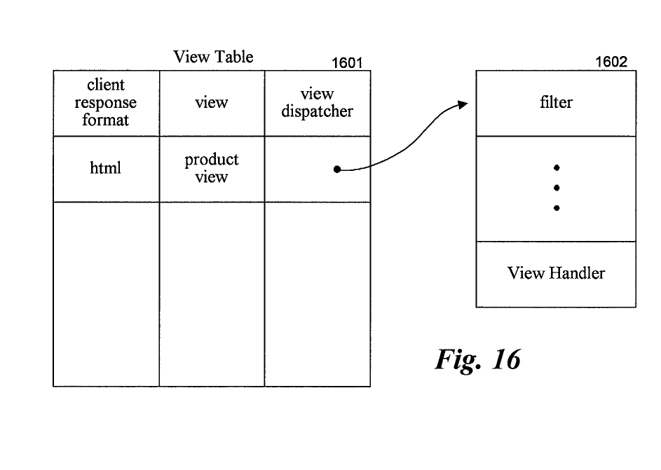

FIG. 16 is a block diagram illustrating the layout of the view table of the application framework. The application framework generates the view table based on the information contained in the configuration file. The view table 1601 contains an entry for each view that is defined in the configuration file. The entries contain a client response format, a view, and a reference to a dispatcher for invoking the filters in sequence and then the view handler as indicated by the view component table 1602. For example, the first entry of the view table indicates that the client response format is “html” and the view is “product-view.”

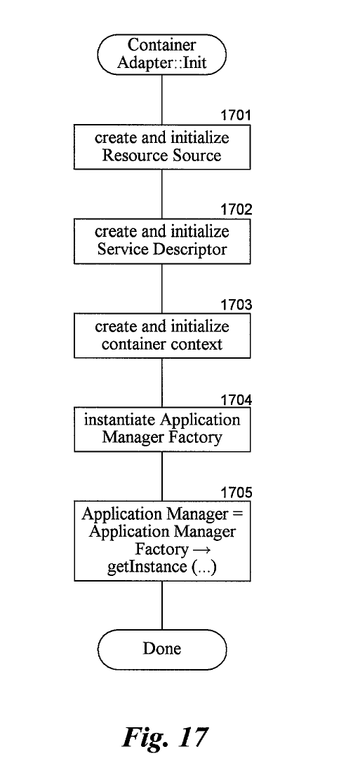

FIG. 17 is a flow diagram illustrating the initialization of an application program by the container adapter. The container adapter provides an initialize method that initializes the application program in accordance with configuration files and initialization parameters. The initialize method is invoked when the container adapter is instantiated. In block 1701, the method creates and initializes a resource source object that defines the configuration information for the application program. In block 1702, the method creates and initializes service descriptor objects that describe the various services that are provided to the application program. In block 1703, the component creates and initializes a container context object that specifies container information that may be needed by the application program. In block 1704, the method instantiates an application manager factory object for creating an instance of an application manager object. An application manager object corresponds to the application framework. In block 1705, the method invokes the get instance method of the application manager factory object passing a class loader, the resource source object, the service descriptor objects, and the container context object. The get instance method returns a reference to the application manager object after loading the application program in accordance with the configuration files. The method then completes.

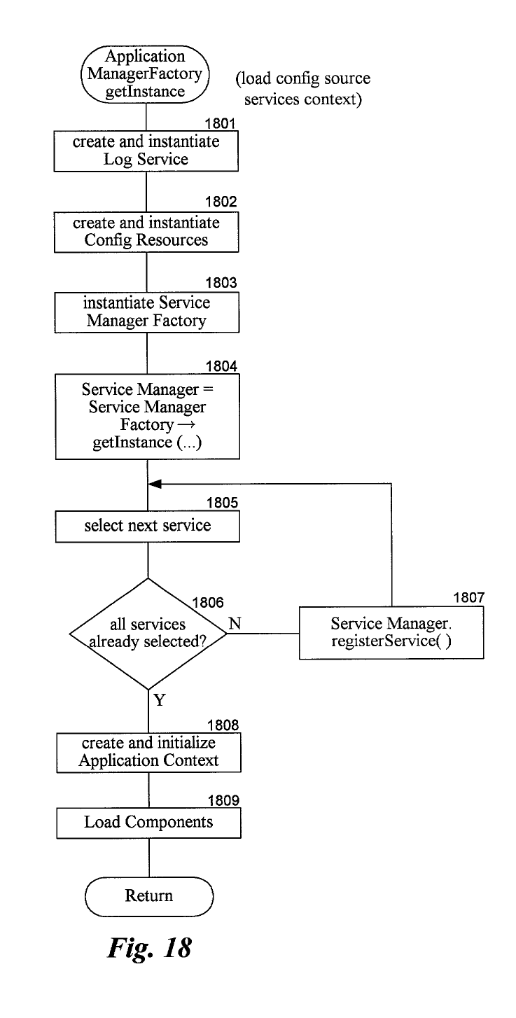

FIG. 18 is a flow diagram of the get instance method of the application manager factory object. This method is passed a class loader, a resource source object, service descriptor objects, and a container context object. In blocks 1801-1802, the method creates and initializes standard service objects that are provided by the application architecture. In this example, the method creates a log service object and a configuration resource service object. In blocks 1803-1807, the method loops registering each service specified in the service descriptor objects. In block 1803, the method creates and initializes a service manager factory object. In block 1804, the method invokes the get instance method of the service manager factory object to retrieve a reference to a service manager object. In block 1805, the method selects the next service description object. In decision block 1806, if all the service descriptor objects have already been selected, then the method continues at block 1808, else the method continues at block 1807. In block 1807, the method registers the service of the selected service descriptor object with the service manager object and then loops to block 1805 to select the next service descriptor object. In block 1808, the method creates and initializes an application context object. In block 1808, the method controls the loading of the various components of the application as specified by the configuration files by invoking the load components function.

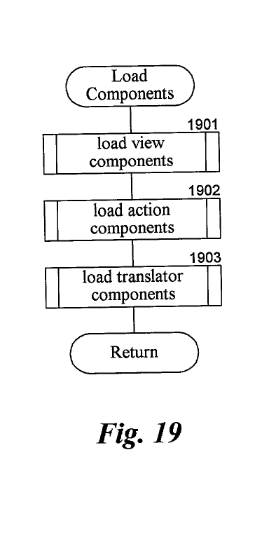

FIG. 19 is a flow diagram of the processing of the load components finction. This function loads the view components, the action components, and the translation components of the application program in accordance with the configuration files. In block 1901, the component invokes a load view components function to load the view components. In block 1902, the function invokes a load action components function to load the action components. In block 1903, the function invokes the load translation components function to load the translation components and then returns.

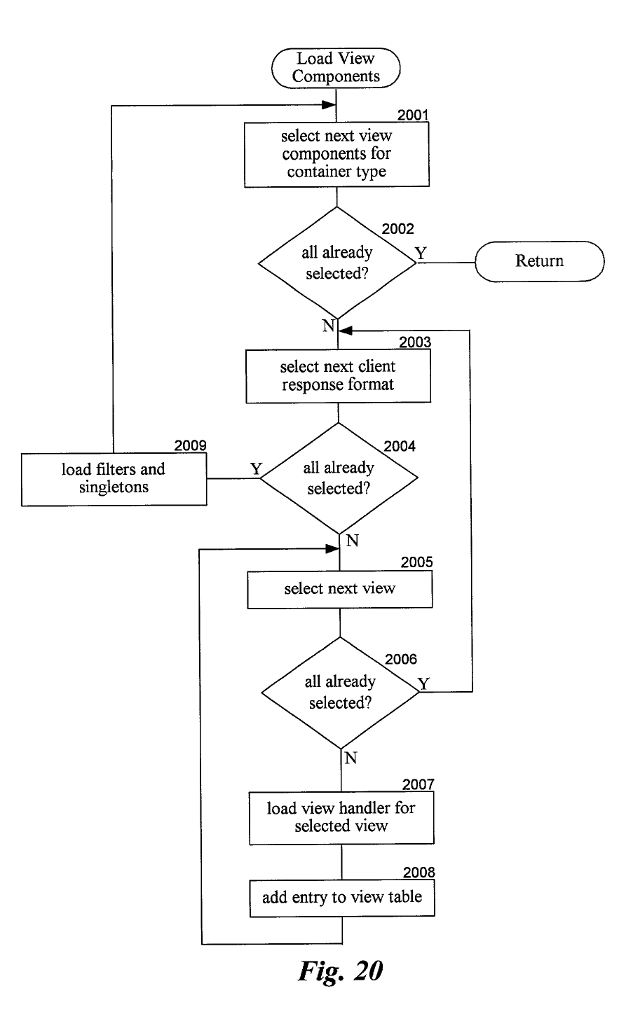

FIG. 20 is a flow diagram of the processing of the load view components function. The function retrieves the view component information from the configuration file, instantiates the view handlers, updates the view table, and instantiates the view filters and singletons for the view layer. In block 2001, the function selects the next view component for a container type from the configuration file. In decision block 2002, if all the view components have already been selected, then the function returns, else the function continues at block 2003. In block 2003, the component selects the next client response format for the selected view component. In decision block 2004, if all the client response formats have already been selected, then the function continues at block 2009, else the function continues at block 2005. In block 2005, the function selects the next view of the selected client response format. In decision block 2006, if all the views have already been selected, then the function loops to block 2003 to select the next client response format for the selected view component, else the function continues at block 2007. In block 2007, the function loads the view handler of the selected view. In block 2008, the function adds an entry to the view table that maps the selected client response format and the selected view to the loaded view handler. The function then loops to block 2005 to select the next view. In block 2009, the function loads the filters and singletons specified in the configuration file for the selected view component. The function then loops to block 2001 to select the next view component.

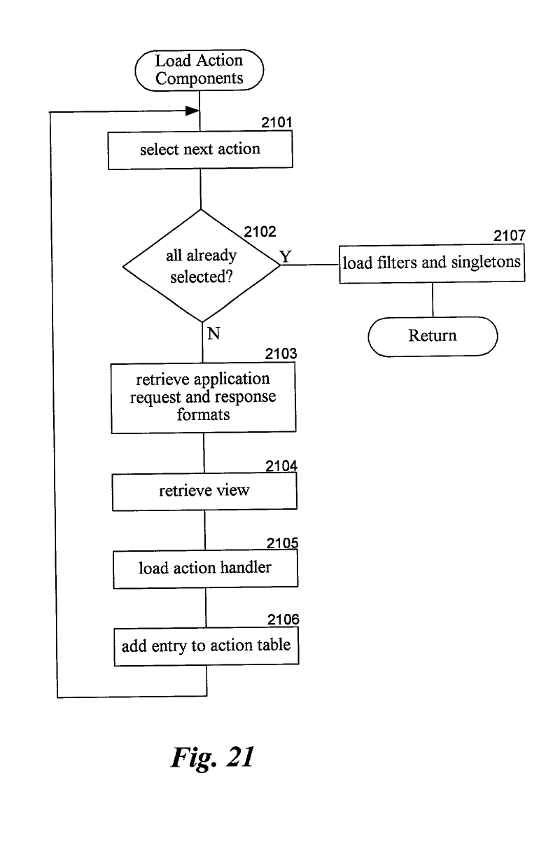

FIG. 21 is a flow diagram of the processing of the load action components function. This function retrieves the action component information from the configuration file, loads the action handlers, updates the action table, and loads the filters and singletons for the action layer. In blocks 2101-2106, the function loops loading each action handler. In block 2101, the function selects the next action from the configuration file. In decision block 2102, if all the actions already selected, then the function continues at block 2107, else the function continues at block 2103. In block 2103, the function retrieves the application request and response formats for the selected action. In block 2104, the function retrieves the view of the selected action. In block 2106, the function loads the action handler of the selected action. In block 2106, the finction adds an entry to the action table and loops to block 2101 to select the next action. In block 2107, the function loads the filters and singletons for the action layer and then returns.

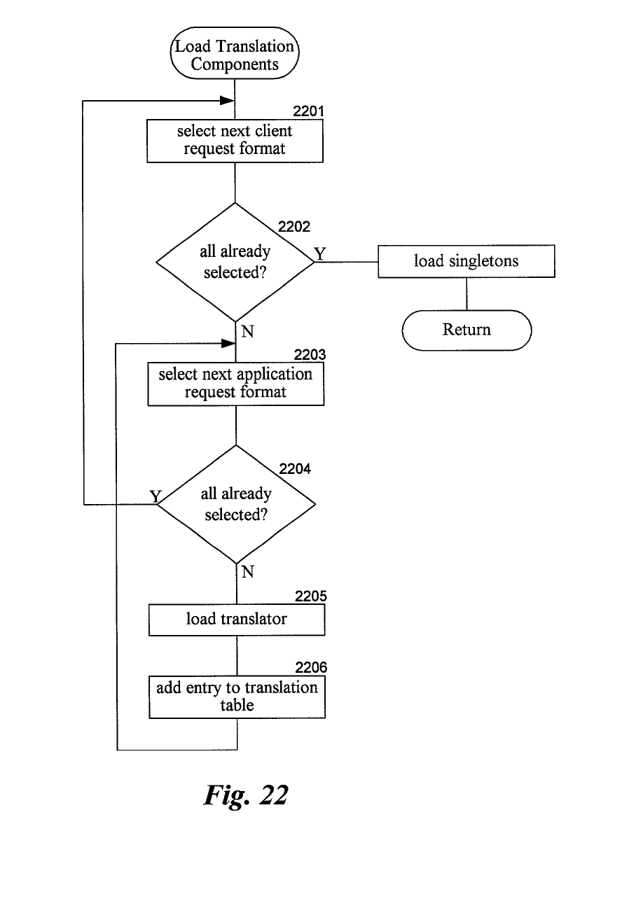

FIG. 22 is a flow diagram of the processing of the load translation components function. This function retrieves the translator components information from the configuration file, loads the translators, updates the translation table, and loads the singletons for the translation layer. In block 2201, the component selects the next client request format. In decision block 2202, if all the client request formats have already been selected, then the function returns, else the function continues at block 2203. In block 2203, the function selects the next application request format for the selected client request format. In decision block 2204, if all the application request formats have already been selected, then the function loops to block 2201 to select the next client request format. In block 2205, the function loads the translator for the selected application request format and the selected client request format. In the block 2206, the function adds an entry to the translation table that maps the translator to translate the selected client request format to the selected application request format and loops to block 2203 to select the next client request format.

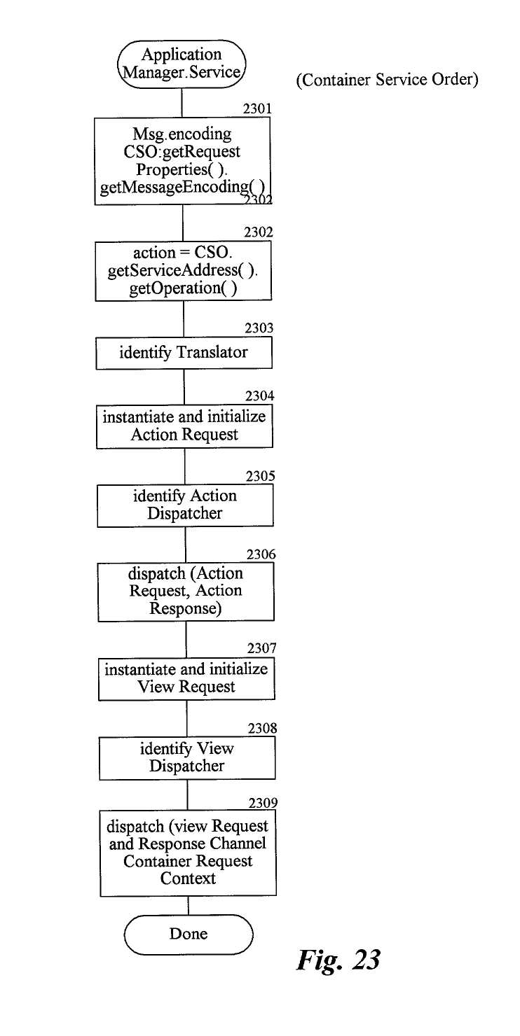

FIG. 23 is a flow diagram of the processing of the service method of an application service manager object. This method is invoked by the container adapter to provide an action request to an application program. The method is passed a container service order object that encapsulates an action request object. In block 2301, the method retrieves the client request format from the service order object. In block 2302, the function retrieves the action name from the client service order object. In block 2303, the method identifies a translator by retrieving the application request format for the action from the action table and then using the client request format and the application request format to identify the translator from the translation table. In block 2304, the method instantiates an action request object and an action response object. The method stores a reference to the identified translator in the action request object. In block 2305, the component identifies the action dispatcher from the action table. In block 2306, the method invokes the dispatch method of the action dispatcher passing an action request object and action response object. In block 2307, the method instantiates a view request object and stores an indication of the client response format and the view returned by the action handler. In block 2308, the method identifies the view dispatcher from the view table using the client response format and the view. In block 2309, the method invokes the dispatcher passing the view request object, response channel object, and container request context object. The method then completes.

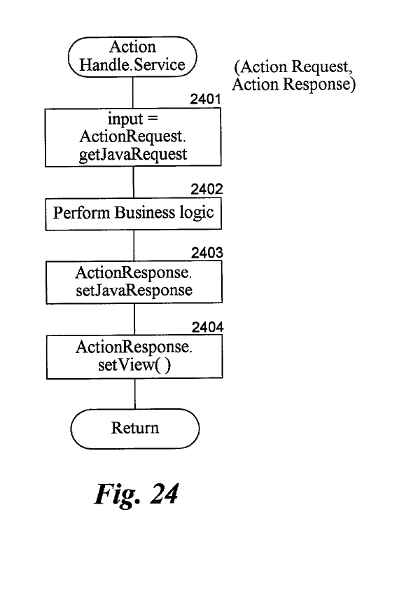

FIG. 24 is a flow diagram illustrating the processing of the service method of an action handler. This method is passed an action request object and an action response object. In block 2401, the method retrieves the request message by invoking a finction of the action request object. In block 2402, the method performs the business logic associated with the action. In block 2403, the method sets the response in the action response object. In block 2404, the method sets the view in the action response object and then returns.

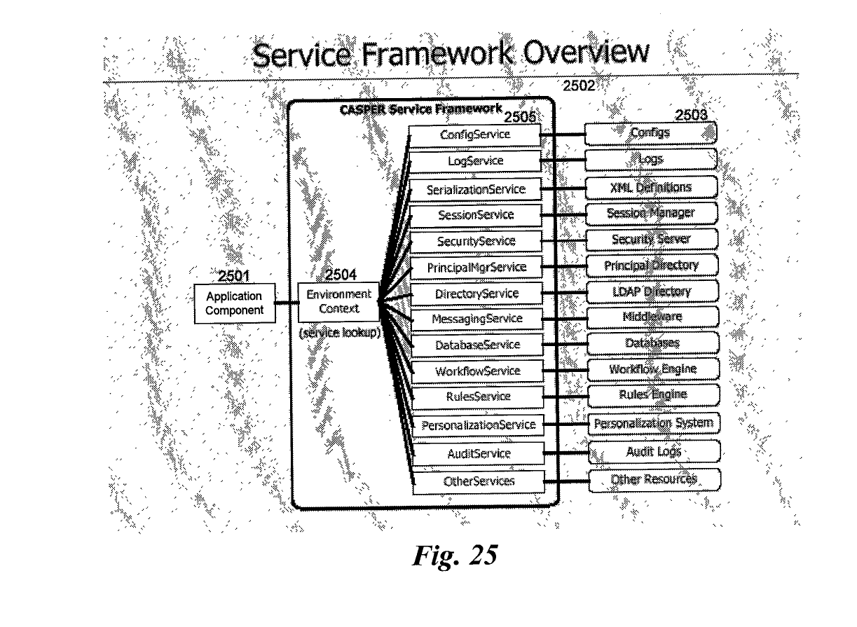

FIG. 25 is a block diagram illustrating the architecture of the service framework in one embodiment. An application component 2501, such as an action handler, uses the service framework 2502 to access various underlying services 2503. The service framework provides a generic mechanism for accessing services that are provided to an application program. When an application program is loaded, the services defmed by a services configuration file are also loaded. The application program is provided with a reference to an environment context object 2504 through which the application program can access the various services. To access a service, the application program invokes a lookup method of the environment context object passing the name of the service. The lookup method retrieves a reference to the interface for that service and returns it to the application component. The application component can then invoke the methods on the interface of that service to effect the performance of services. The interfaces provided by the services are published to the developers of the application programs.

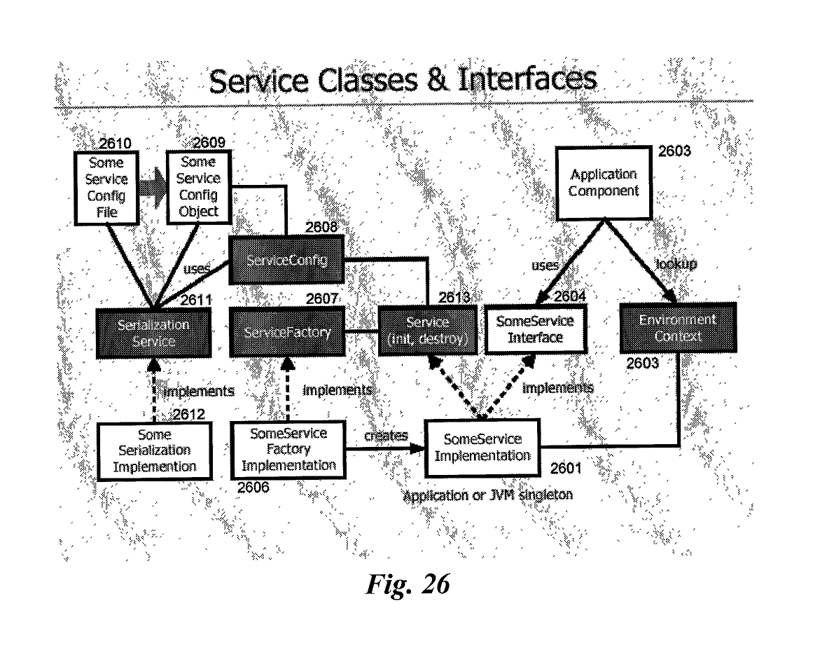

FIG. 26 is a block diagram illustrating the architecture of the service framework using an example local service 2601. A service implementation for the local service is specified by a configuration file 2610, and the local service is instantiated at load time of an application program 2602 under control of the application manager for the application program. The executing application program then invokes the service by first invoking the lookup method of the environment context object 2603 and receiving an interface 2604 to the service. The application program can then use the interface to access functionality provided by the service.

The instantiation of the service is performed by a service factory object 2606 that is created by the application manager using service factory class information specified in the configuration file. The service factory object implements a service factory interface 2607 that can be used to instantiate the service. The application manager also creates a service configuration object 2609 having an interface 2608 through which the service can receive its configuration information when it is started. The service configuration object may also use the functionality of the serialization service 2612 having an interface 2611 (described below) to retrieve the configuration information. In particular, the application manager invokes an initialize method of the service interface 2613 for the service implementation 2601, passing the service configuration object.

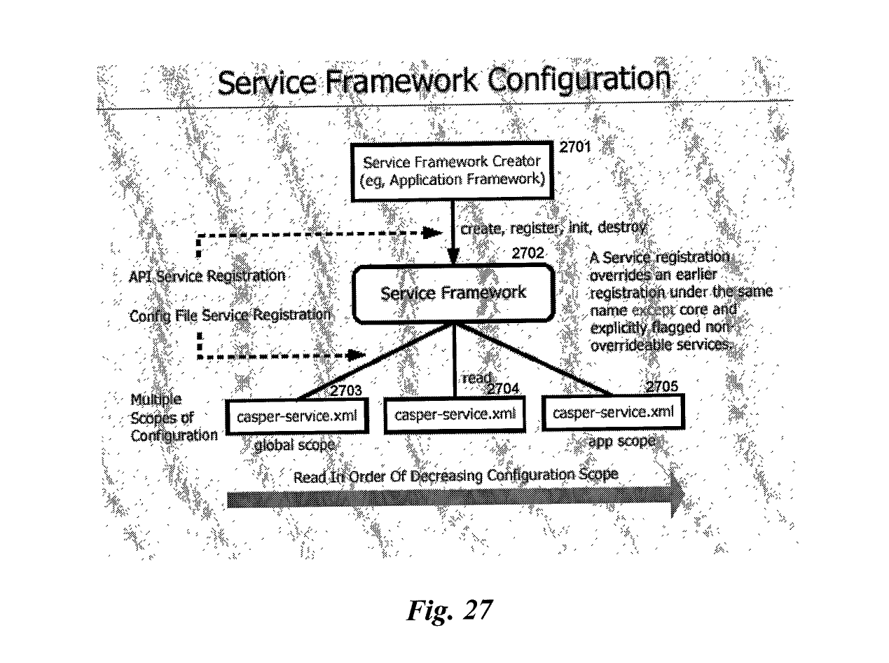

FIG. 27 is a block diagram illustrating the configuring of the service framework. The application manager creates the service framework 2701 by instantiating a service manager factory object that controls the registration of services that are defined in configuration files. The configuration files may represent a hierarchy of a configuration information in which the first processed configuration file represents the broadest scope of configuration information and the last configuration file processed represents the narrowest scope of configuration information. In one embodiment, a service defined in a narrower scope configuration file overrides the service defined in a broader scope configuration file.

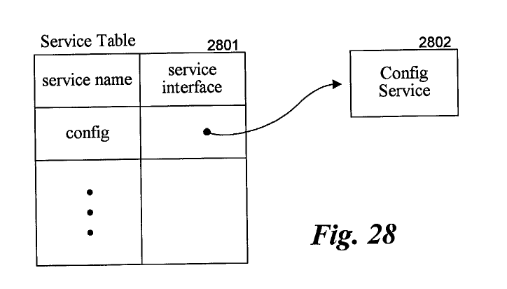

FIG. 28 is a block diagram illustrating a service table in one embodiment. The service table is generated when services are initialized and contains a mapping from the name of services to the interfaces provided by the services. The service table 2801, which is maintained by the service framework, contains an entry for each service that has been defined (i.e., initialized). The entries include the name of the service along with a reference to the service interface provided by that service. As indicated by the first entry in the service table, the name of the first example service is “config,” and the service interface points to the configuration service 2802.

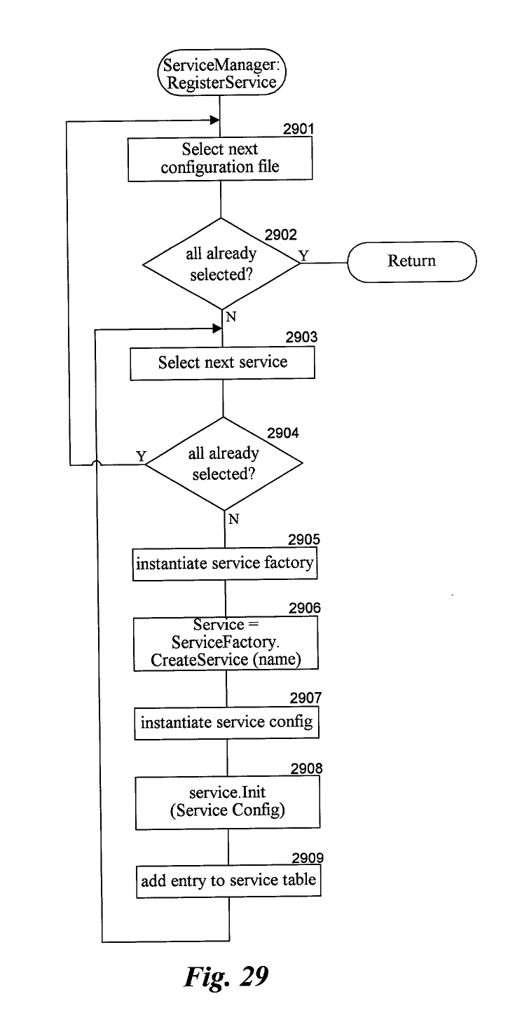

FIG. 29 is a flow diagram illustrating the processing of the register service method of the service manager object in one embodiment. The application manager instantiates a service manager factory object, which in turn provides a reference to a service management object. The service management object provides methods for registering services with the service framework. The register service method is used to register services that are defmed in the various configuration files. In block 2901, the method retrieves the next configuration file. In decision block 2902, if all the configuration files have already been selected, then the method returns, else the method continues at block 2903. In blocks 2903-2909, the method loops selecting and registering the services defmed in the selected configuration file. In block 2903, the method selects the next service of the selected configuration file. In decision block 2904, if all the services of the selected configuration file have already been selected, then the method loops to block 2901 to select the next configuration file, else the method continues to block 2905. In block 2905, the method instantiates a service factory object for the selected service as indicated by the selected configuration file. In block 2906, the method invokes the create service method of the service factory object and receives a reference to a service object in return. In block 2907, the method instantiates a service configuration object. In block 2908, the method invokes the initialize method of the service object passing the service configuration object. In block 2909, the method adds an entry to the service table for the selected service and then loops to block 2903 to select the next service for the selected configuration file.

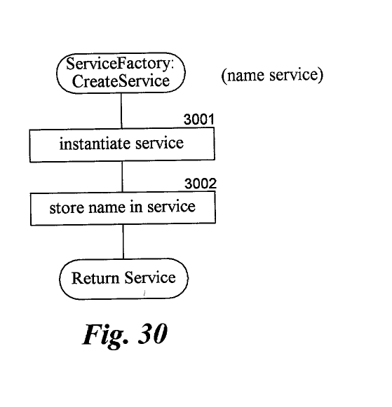

FIG. 30 is a flow diagram illustrating the processing of the create service method in one embodiment. The fimction is passed the name of the service and returns a reference to the service object. In block 3001, the method instantiates the service. In block 3002, the method stores the passed name in the service object and then returns a reference to the service object.

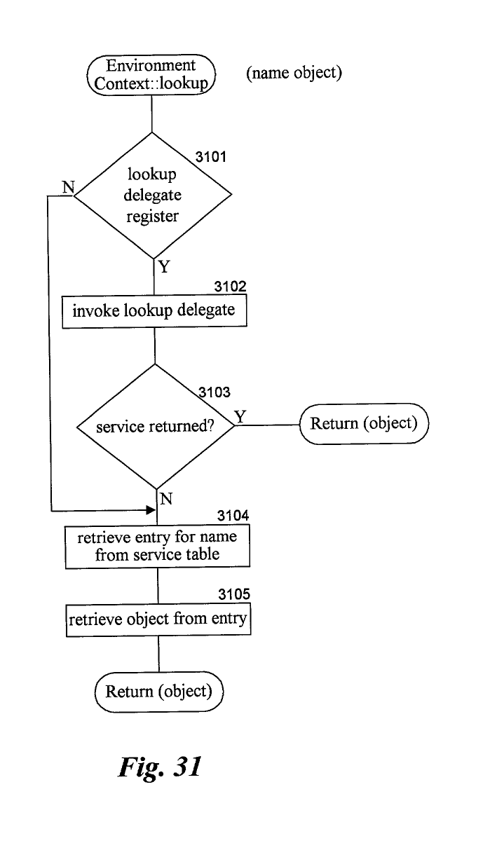

FIG. 31 is a flow diagram of the lookup method of the enviromnent context object. This method is passed the name of a service, identifies the object (interface) associated with that service from the service table, and returns a reference to the service object that implements that service. In block 3101, if a lookup delegate object has been registered for the service, then the method continues at block 3102, else the method continues at block 3104. The service framework allows an application program to register a delegate lookup object. If registered, the service framework delegates the lookup of the service object to that object. In this way, an application program can effectively override previously defmed services. In block 3102, the function invokes the lookup method of the delegate object to determine whether a service of the passed name is provided by the delegate object. In decision block 3103, if a service is returned by the delegate object, then the method returns, else no overriding service of that name was found by the delegate object and the method continues at block 3104. In block 3104, the method retrieves the entry for the passed name from the service table. In block 3105, the method retrieves the service object from the retrieved entry and returns the service object.

The serialization service in one embodiment provides a generic mechanism for converting XML data into a Java object and vice versa. As described in more detail in the “schema compiler” patent application, a schema compiler inputs XML data type definitions and automatically generates serialization/deserialization code and validation code for that XML data type definitions. The deserialization code converts the XML data into a Java object, and the serialization code converts a Java object into XML data. The serialization service may be invoked by the application components (e.g., action handlers and translators) to convert XML data to a Java object and vice versa. When the serialization service is configured, it is provided with a mapping of XML data type definitions to Java class definitions for serialization, deserialization, and validation that are tailored to the application program that is being loaded. When the application program invokes a method of an action request object to retrieve the request message, the translator is invoked. The translator may use the serialization service to serialize and deserialize the request message as appropriate. In addition, the translator may use the validation code to validate the XML data.

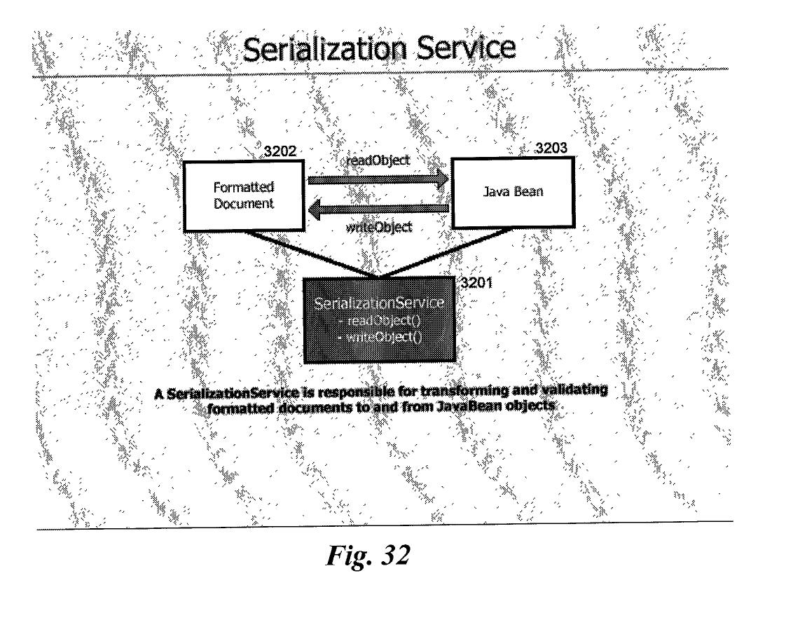

FIG. 32 is a block diagram illustrating invocation of the serialization service. The serialization service 3201 provides a read object method for deserializing an XML formatted document 3202 and a write object method for serializing a Java object 3203. The read object and write object methods may be invoked by a translator or other application program component, such as an action handler during its initialization.

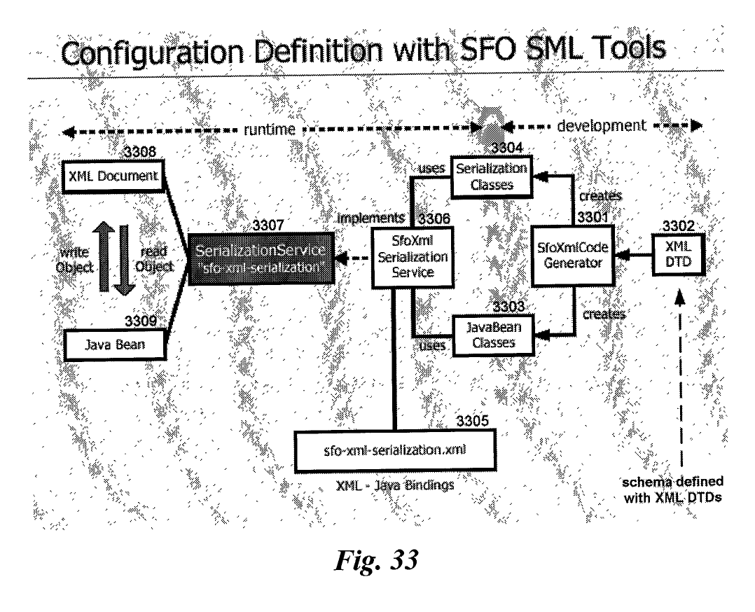

FIG. 33 is a block diagram illustrating the architecture of the serialization service in one embodiment. When an application program is being developed, XML data type definitions 3302 are generated for the messages and for the configuration files to be used by the application program. The XML code generator 3301 inputs the XML data type definitions and outputs class definitions 3303 for the Java objects and outputs serialization classes 3304. The serialization classes are used to serialize, deserialize, and validate the XML data. At runtime, the serialization service 3306 uses the Java object classes and deserialization classes to provide the serialization interface 3307.

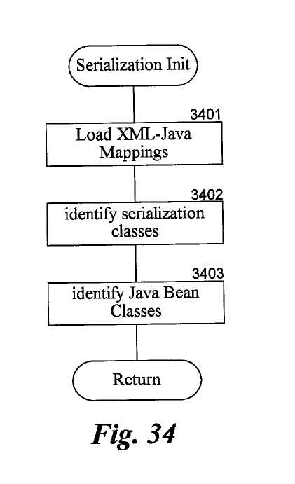

FIG. 34 is a flow diagram illustrating the initialize method of the serialization service in one embodiment. The method loads the XML-to-Java mappings, identifies the serialization classes, and identifies the Java object classes from various configuration files. In block 3401, the method loads the XML-to-Java mappings, which map various XML formats to Java object classes. In block 3402, the function identifies the serialization classes. In block 3403, the function identifies the Java object classes and then returns.

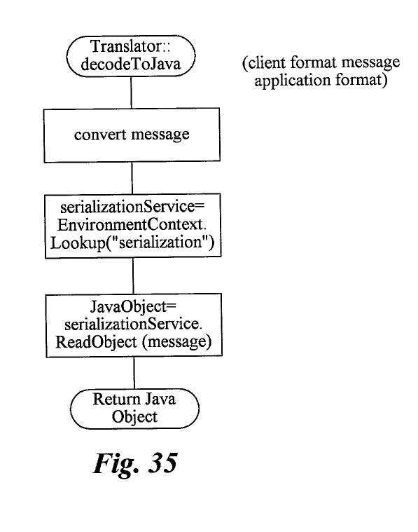

FIG. 35 is a flow diagram illustrating the processing of the decode-to-Java method of a translator in one embodiment. This method is passed an indication of the client format, the message to be translated, and the application format. The method deserializes the message and returns the Java object representing the message. In block 3501, the method performs any processing necessary to convert the message from the client format to the application format. In block 3502, the method retrieves a reference to the serialization service by invoking the lookup method of the enviromnent context object. In block 3503, the method invokes the read object method of the serialization service passing the message to be deserialized into a Java object. The method then returns the Java object.

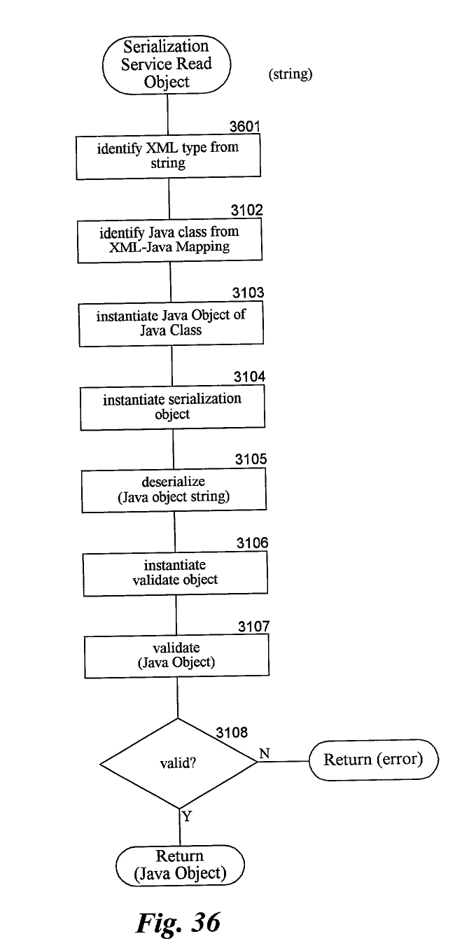

FIG. 36 is a flow diagram illustrating the processing of the read object method of the serialization service in one embodiment. The read object method is passed a string containing the XML data and returns a Java object. In block 3601, the method identifies the XML type from the string. In block 3602, the method identifies the Java class for the Java object to be returned and identifies a class for performing the serialization and validation associated with the identified Java class. In block 3603, the method instantiates a Java object of the identified Java class. In block 3604, the method instantiates a serialization object. In block 3605, the method invokes the deserialize method of the serialization object passing the reference to the Java object. In block 3606, the method instantiates a validation object. In block 3607, the method invokes the validate method of the validation object passing the Java object. In decision block 3608, if the data of the Java object is valid, then the method returns the Java object, else the method returns an error.

The application architecture also provides a configuration service to facilitate the configuring of application components. In one embodiment, the configuration service allows an application program to be configured in accordance with multiple layers of configuration information. Each layer of configuration information represents a decreasing scope. For example, the first layer of configuration information may represent global information that is applicable to all application programs that use the application architecture. The second layer of configuration information may represent information that is applicable to only those application programs that operate in a web environment. The third layer of configuration information may represent information that is applicable only to a certain application program. The configuration information may be stored in configuration files in various directories known to the configuration service through its own configuration information. The configuration service returns an interator through which an application program can successively retrieve the configuration information of decreasing scope.

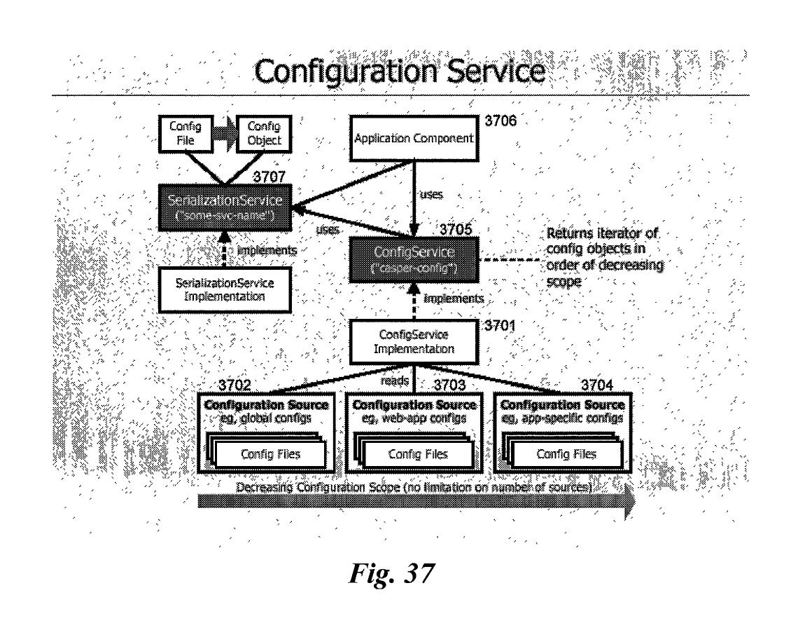

FIG. 37 is a block diagram illustrating the architecture of the configuration service in one embodiment. The configuration service implementation 3701 accesses various configuration sources 3702, 3703, and 3704 of decreasing scope. An application component 3706 uses the configuration service interface 3705 to retrieve the iterator for the configuration information. The configuration service may itself use the serialization service 3707 to retrieve the configuration information. In particular, each of the configuration files may be an XML document that is known to the serialization service. When requested by the configuration service, the serialization service deserializes the configuration file into a Java object that is used by the application components.

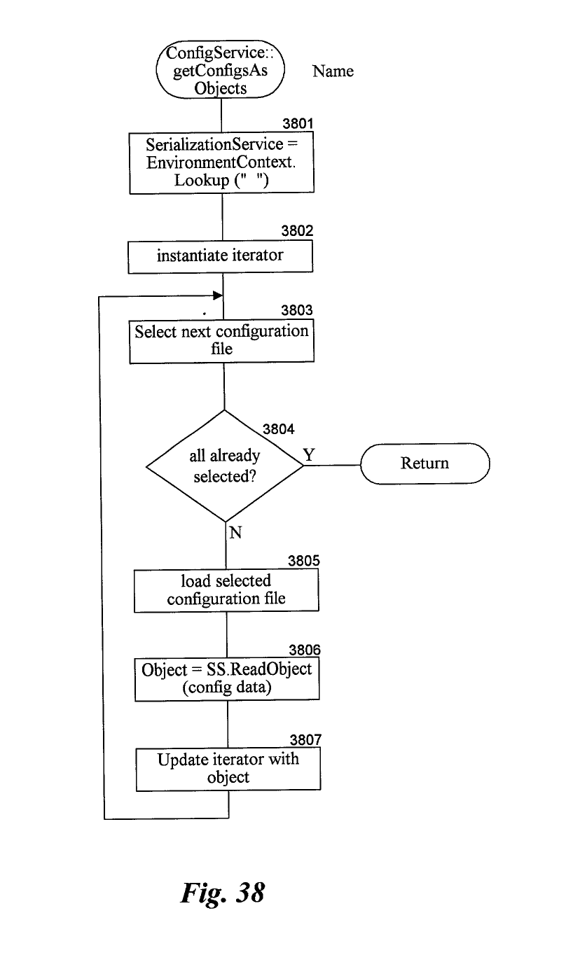

FIG. 38 is a flow diagram illustrating a get-configuration-as-objects method of the configuration service in one embodiment. This method is passed the name of the configuration files to retrieve and returns an interator for retrieving the Java objects representing the configuration files. In block 3801, the method invokes the lookup method of the environment context object to retrieve the reference to the serialization service. In block 3802, the method instantiates an iterator through which the Java objects corresponding to the deserialized configuration information can be retrieved. In blocks 3803-3807, the method loops selecting each configuration file and deserializing it. In block 3803, the method selects the next configuration file, starting with the configuration file with the broadest scope. In decision block 3804, if all the configuration files have already been selected, then the method returns the iterator else the method continues at block 3805. In block 3805, the method loads the selected configuration file. In block 3806, the method invokes the read object method of the serialization service passing the configuration information of the selected configuration file. The read object method returns the deserialized Java object. In block 3807, the method updates the iterator to include the deserialized Java object and then the loops to block 3803 to select the next configuration file.

In addition to local services (e.g., the configuration service and serialization services) that are instantiated for each application program, some application programs may desire to communicate with remote services that are not instantiated separately for each application program (e.g., a single executing legacy program that may communicate with many application programs). Such remote services are also referred to as “shared services” because they may be shared by many application programs. In order to communicate with application programs, each such remote shared service defines an access interface that the application programs can use to send messages to the remote shared service. After receiving a message from an application program that requests some type of finctionality, the shared service can then the requested finctionality and optionally return a response message. In order to facilitate communication, the various defmed access interfaces can be stored in some embodiments in a manner accessible to others (e.g., in a centralized storage location). In addition, in some embodiments each application program has a local messaging service component that is able to use the access interfaces for one or more remote shared services in order to communicate with those shared services, as described in greater detail below.

More generally, in some embodiments a client component (e.g., an application program) uses the stored access interface information for a server component (e.g., a remote shared service) in order to communicate with the server component. The client component can send a message to the server component, with a messaging component (e.g, a local messaging service) assisting in the sending of the message. In some embodiments, the messaging component can translate a message into a format understood by a particular recipient server component, can choose an appropriate transport service (e.g., HTTP, DCOM, SQL, MQSeries, etc.) for sending the message to the recipient, can provide any necessary security services, and can provide any necessary additional processing needed to communicate with the recipient.

In addition, the messaging component can also provide in some embodiments a variety of messaging models that determine how a message is provided to one or more recipients, as well as how the recipients respond to the message. For example, the messaging component may provide both synchronous and asynchronous communications, such as with messaging models including request-reply, one-way, store-and-forward, queued, publish-subscribe, and conversational.

In some embodiments, multiple internal components are provided by a single entity (such as via an intranet), and an internal passthru component is provided to allow external components from other entities (such as via the Internet or an extranet) to communicate with one or more of the internal components. The passthru component can interact with the messaging component so that message translation, transport service selection, and security services are available to the external component through the passthru component.

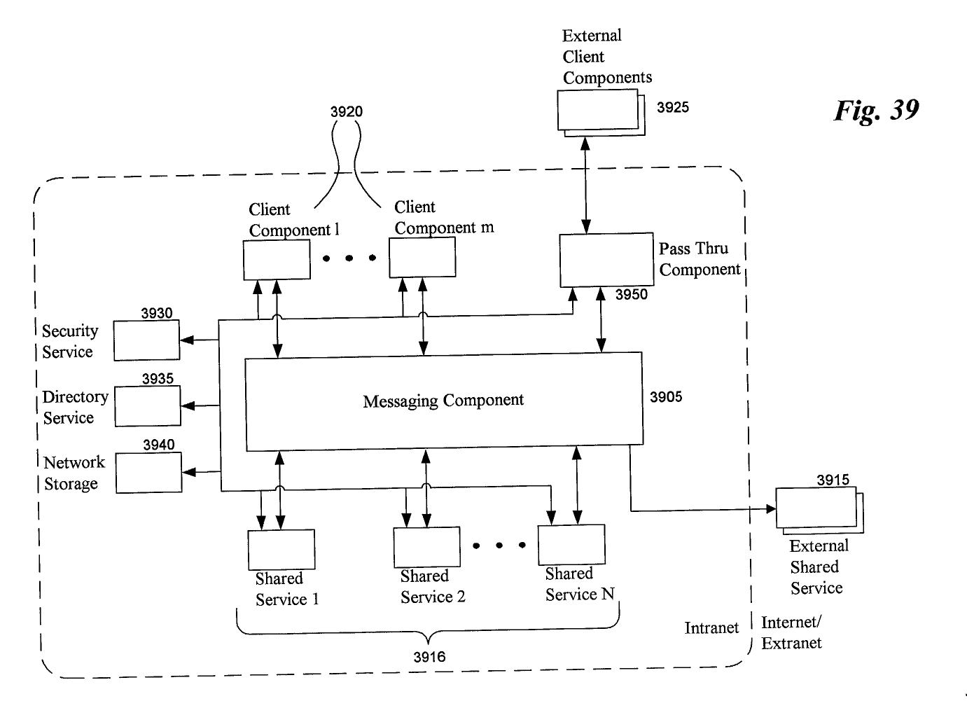

FIG. 39 is a block diagram illustrating an embodiment of a variety of components communicating and transferring information, including a messaging component 3905 for facilitating the communication and information transfer. In particular, a variety of shared service server components 3910 and 3915 are present, with each shared service implementing some type of business process or logic (e.g., a parts ordering capability that provides various functions to create an order, obtain order details, etc.) that is available to other components such as client components 3920 and 3925.

In the illustrated embodiment, a single entity provides shared services and clients within an intranet 3900. These intranet components may interact with each other, and may also provide functionality (e.g., e-commerce functionality) to shared services and clients outside the intranet, such as those of consumers or other businesses (e.g., customers and suppliers in a business supply chain). The illustrated shared services thus include shared services 3910 located within the intranet and one or more external shared services 3915 located outside the intranet (e.g., supplier shared services). Similarly, the clients can include clients 3925 outside the intranet (e.g., corporate customers) as well as clients 3920 within the intranet.

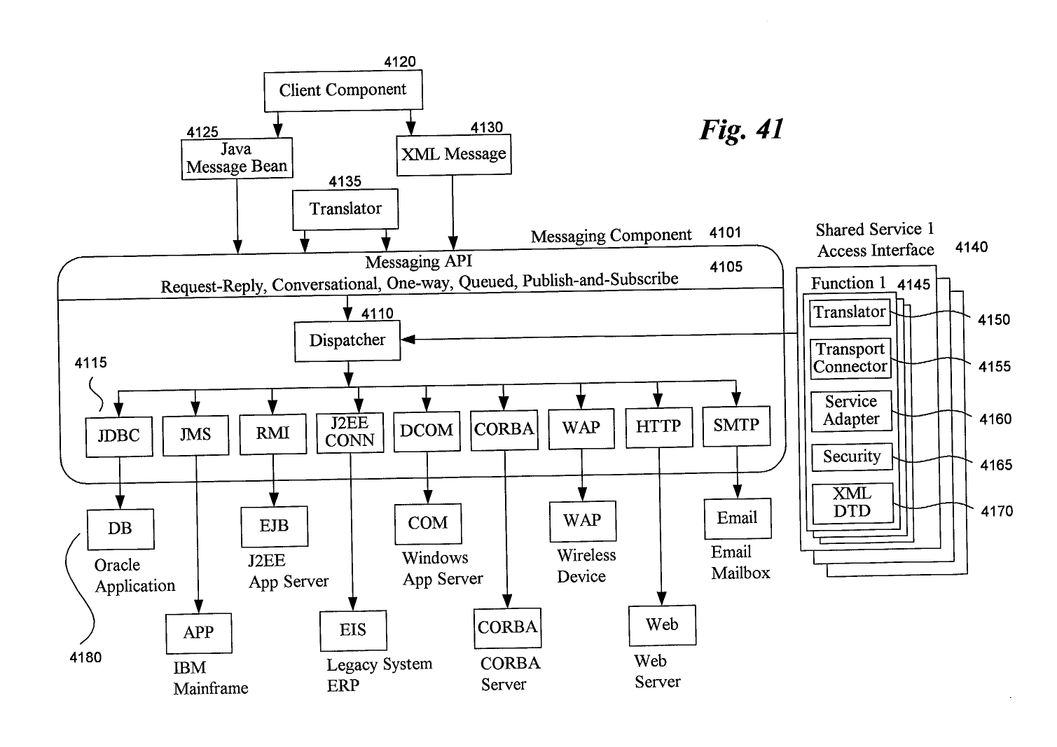

In order to provide services to clients, each shared service registers an access interface that includes information on how to access one or more sets of functionality provided by the shared service. The access interface information can take a variety of forms, discussed in greater detail with respect to FIG. 41. In addition, the access interface information can be stored in a variety of ways. For example, in some embodiments the access interface information for a shared service is stored once at the time the shared service is first installed, such as manually by a developer or automatically by an installation routine. In other embodiments, the access interface information can be provided dynamically by the shared service whenever the shared service becomes available, such as to an executing messaging component.

The access interface information for a shared service can be made available to other components in a variety of ways. For example, the access interface information may be stored in a globally accessible location, such as with directory service 3935 (e.g., a Lightweight Directory Access Protocol (LDAP) directory service) or on a network storage device 3940 (e.g., in a database). In other embodiments the messaging component may directly store the access interface information, or each shared service may instead dynamically provide the access interface information upon request.

When a client within the intranet desires to access a set of functionality provided by a shared service, the client sends a message to the messaging component with the appropriate information. Upon receipt of such a message, the messaging component retrieves the access interface information for the set of functionality from the shared service, and uses the access interface information to determine how to invoke the set of functionality. The sending of messages is discussed in greater detail with respect to FIG. 41. The messaging component can contact different shared services (e.g., internal versus external shared services, and Java-enabled versus non-Java-enabled shared services) in differing manners as needed, and can also perform additional finctions before sending messages such as invoking a security service 3930 (e.g., Netegrity SiteMinder) to provide system-wide security functions. In addition, if one or more response messages are sent, the messaging component can return the responses to the requesting client in an appropriate manner.

In the illustrated embodiment, a passthni component 3950 is provided that allows external clients to access services provided by registered shared services. In particular, the passthru component receives messages from the external clients (e.g., a serialized extensible mark-up language (XML) message sent over the Internet using the HTTP protocol), and forwards the messages to the messaging component. In some embodiments and some situations, the passthru component may perform additional processing on received messages so that the message sent to the messaging component is in an appropriate format. In addition, if one or more response messages are received by the passthru component from the messaging component, the passthrn component returns the responses to the requesting client in an appropriate manner.

Those skilled in the art will appreciate that a variety of types of shared services and clients may be available. The shared services and clients can include both commercial software and custom-designed software, and can include both new and legacy applications. The shared services and clients can also include applications supporting various languages and technologies (e.g., both Enterprise JavaBean (EJB) components and non-Java components), as well as a variety of types of applications (e.g., on-line applications and internal corporate systems) executing on a variety of types of devices (e.g., wireless handheld devices and Internet-accessible clients and servers).

In addition, those skilled in the art will appreciate that the illustrated embodiment is for explanatory purposes, and is not intended to limit the scope of the invention. In some embodiments all of the various components and shared services may be within a secure environment such as an intranet, while in other embodiments no such environment may exist. In addition, while a particular shared service may provide functionality to other clients at times, that particular shared service may also be a client to other shared services at other times. Also, while a single messaging component serves multiple client components in the illustrated embodiment, in alternate embodiments each client component could use a separate instantiation of the messaging component.

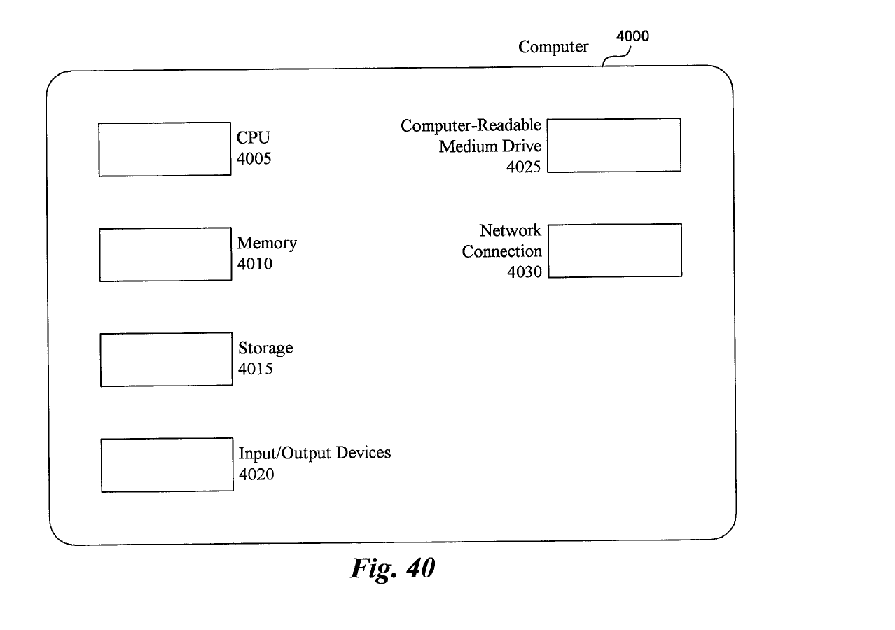

FIG. 40 is a block diagram illustrating a computer system capable of executing one or more shared service server components and/or client components. The computer 4000 includes a CPU 4005 for executing instructions, a memory 4010 for storing instructions (e.g., of an executing component) and data to be used during execution, and input/output devices 4020 to allow information to be received from and sent to a user. The computer may also contain a non-volatile storage 4015 for storing instructions (e.g., of one or more components) and data, a computer-readable medium drive 4025, and a network connection 4030.

Those skilled in the art will appreciate that computer system 4000 is merely illustrative and is not intended to limit the scope of the present invention. For example, in alternate embodiments, a single computer may execute only a portion of a component (e.g., in parallel processing or distributed computing situations). Any data structures created or used, such as access interfaces, may be stored on a computer-readable medium. Moreover, such instructions and data structures can also be transmitted as generated data signals on a variety of computer-readable transmission mediums, including wireless-based and wired/cable-based mediums. Computer system 4000 may also contain additional components or may lack some illustrated components, and may be connected to other devices in a variety of manners, including through a network, through the Internet, or via the World Wide Web (WWW). Accordingly, the present invention may be practiced with other computer system configurations.

FIG. 41 is a block diagram illustrating an embodiment of a messaging component 4101 that is processing a message sent from a client component 4120. In particular, the messaging component includes a messaging API 4105 that supports a variety of types of messaging models, a dispatcher component 4110 that receives messages from clients and forwards them to shared services in appropriate formats, and a variety of shared service adapters 4115 for communicating with shared services of various types.

In the illustrated embodiment, a variety of shared services are providing one or more sets of functionality to clients, with each such shared service having an associated defined access interface 4140. Each access interface for a shared service has a group of information 4145 for each function from that shared service that is made available to others. Each shared service is given a unique logical name, and each accessible function for that shared service is given a logical name unique within the shared service. Those skilled in the art will appreciate that the access interfaces can be stored or provided in a variety of manners as discussed above.

In the illustrated embodiment, each shared service shares a common format for messages in order to enhance communication with other components, with that common format being extensible mark-up language (XML). XML is a markup language for documents that contain structured information, with XML 1.0 defined by the Worldwide Web Consortium (“W3C”). The definition of XML is available at “HTTP://www.w3c.org/TR/REC-xml,” which is hereby incorporated by reference. Those skilled in the art will appreciate that in other embodiments a different format could be used, and that different shared services could use different formats. For example, Java-based shared services could use Java objects as messages, and other shared services could use XML messages.

As part of the access interface function information group 4145, each function has one or more XML document type definition (DTD) documents 4170. The DTD specifies the parameters for a message (e.g., parameters to be used to invoke the function), as well as information about the parameter types. Each information group 4145 will include a DTD for the request message that a client uses to invoke the function at the shared service, as well as a DTD for the zero or more response messages that the function may return to the requesting client.

In the illustrated embodiment, each function information group 4145 also includes a transport connector 4155, and can optionally include a translator 4150, a service adapter 4160, and a security component 4165. Each of these pieces will be used during the processing of messages sent to that function of the shared service, as described below in greater detail. In alternate embodiments, some or all of these additional pieces may be supplied only once for a shared service access interface 4140 rather than for each function information group 4145. In addition, those skilled in the art will appreciate that the pieces may be actual groups of software, or may instead be an indicator (e.g, a name or a pathname locator) for a group of software. Those skilled in the art will also appreciate that other types of information can be stored in an access interface in other embodiments,. For example, the XML DTDs may be stored separately from the access interface information, or may not be used to specify message format at all.

When a client component wants to invoke functionality from a shared service, the client component sends a message that requests the desired functionality to the messaging component. In the illustrated embodiment, the message specifies a particular function of a particular shared service. In particular, the message includes the logical name of the shared service, the logical name of the function, and a sub-message including parameter information for the function to be invoked. In the illustrated embodiment, the message may be a message 4125 in which the sub-message is an object such as a JavaBean. While such a format allows the client to easily encapsulate a variety of information within the message, such a message will only be understandable to components that support such object information (e.g., an EJB component). Alternately, the message may be a message 4130 in which the sub-message is specified in serialized XML format. Those skilled in the art will appreciate that a variety of other message formats could be used.

Those skilled in the art will also appreciate that the client component could be one of a variety of different types of applications, including a dedicated client within the intranet (e.g., a browser application or an application within an application framework), a shared service requesting functionality from another shared service, a passthru component relaying a message from an external client, etc. Based on the client component and the particular type of message sent, in some embodiments and in some situations (e.g., when a message from a legacy external application is received) the message may need to be passed through a translator 4135 before being sent to the messaging component so that the message is in a format understandable by the messaging component.

In addition, those skilled in the art will appreciate that a client component can determine the appropriate format for a sub-message in a variety of ways, such as by converting the XML DTD for a function request message to a corresponding JavaBean class or other internal representation at the time that the client component is created, or instead dynamically at the time that the client component is to access the shared service. Those skilled in the art will also appreciate that in alternate embodiments a client could invoke functionality of a shared service without knowing a particular function of a particular shared service, such as by identifying the requested functionality with a more general description and allowing the messaging component to select the appropriate function.

When a message is sent from a client to the messaging component, the message is received through the messaging API of the messaging component. In the illustrated embodiment, the messaging API can support a variety of messaging models including request-reply (either synchronous or asynchronous), conversational, one-way, queued, and publish-and-subscribe (i.e., push to designated subscribers or event-driven messaging). The messaging model can be specified in a variety of ways. For example, the message sent to the messaging component may include a parameter specifying the type of messaging model. Alternately, a function may have a different function name and different function information group 4145 for each messaging model supported by the function. In this situation, the messaging model would be inherently specified by the particular function name specified. Another alternative is that the function supports only one type of messaging model, and thus additional messaging model information is not needed. Those skilled in the art will appreciate that in alternate embodiments, other messaging models may be provided and some of the messaging models shown may not be available. In addition, some functions may support only one or a subset of the available messaging models.

After the dispatcher of the messaging component receives the message, the dispatcher is responsible for completing the sending of the sub-message to the identified function as well as for implementing the specified messaging model. The dispatcher first retrieves the function information group for the specified function of the specified shared service, as well as any other information from the access interface information for the shared service that will be needed. The dispatcher next retrieves the software for the translator component specified in the information group, as well as for any specified translator, service adapter or security component. In some embodiments, the messaging component may retrieve the XML DTD for the request message and verify that the sub-message is in an appropriate format, while in other embodiments the sub-message may be assumed to be in an appropriate format.

After retrieving the software for the various specified pieces, the transport connector will be executed to control the sending of the message to the shared service function and to control the receiving of any response messages. In particular, the transport connector will contain specialized knowledge specific to the transport service (e.g., Java Database Access API (JDBC), Java Messaging Service (JMS), Remote Method Invocation (RMI), Java 2 Enterprise Edition (J2EE) Conn, Distributed Component Object Model (DCOM), CORBA, WAP, HTTP, SMTP, MQSeries, etc.) to be used to communicate with the shared service, such as how to establish a connection and how to send and receive messages. The transport connector first establishes a connection with the shared service in an appropriate manner if necessary (e.g., establishes an HTTP connection with a server providing a Web-based shared service), and then determines if a service adapter was specified.

In some situations, a function will have a specified service adapter that needs to perform specialized processing for that finction or that shared service. For example, in some embodiments the standard messaging scheme will be stateless, but some message series may require that state information be maintained between request messages or between multiple response messages for a single request. If a service adapter is specified, the transport connector will execute the service adapter to perform the specialized processing, and will then continue with other regular processing (discussed below). In alternate embodiments, the transport connector may instead turn control of processing over to the service adapter if one is present, and allow the service adapter to perform the regular processing if consistent with the specialized processing of the service adapter.

After the service adapter (if any) has been invoked, the transport connector (or the service adapter if it is controlling execution) then determines the form of the sub-message (e.g., JavaBean or serialized XML) received and determines if the function of the shared service can accept that form. If not, the transport connector invokes the translator to translate the sub-message as necessary. For example, a JavaBean object may need to be converted into an XML format via object serialization. Alternately, a single XML sub-message may need to be converted into a series of multiple SQL calls when accessing a database-based shared service.

Finally, if a security component has been specified (e.g, to perform additional security for calls to this function or shared service), the transport connector (or service adapter) executes the security component to ensure that the specialized security measures have been met before the message will be sent to the specified function of the specified shared service. After the security measures have been met, or if no security component was specified, the transport connector (or service adapter) then sends the sub-message to the shared service through a connector interface 4115 for that type of shared service 4180 (e.g., an Oracle database application, an IBM mainframe application supporting MQSeries, an EJB component provided by a J2EE application server, an Enterprise Information System application such as on a legacy ERP system, a COM component provided by a Windows application server, a CORBA component provided by a CORBA server, a WAP application executing on a wireless device, a Web application provided by a Web server, or an Email application), with the sub-message sent in a manner appropriate to execute the function for that transport service. In some embodiments, the transport connector (or service adapter) sends the sub-message directly to the shared service without using a connector interface supplied by the messaging component.

After the message has been sent to execute the function of the shared service, the transport connector (or service adapter) then waits to receive response messages (if any) from the function. For each response message received, the transport connector performs the same processing discussed (e.g., translation, or additional security measures) in order to send the response message back to the requesting client. If specialized processing is maintaining state information (such as a service adapter), the state information can be updated based on the response messages. After all response messages have been received, the transport connector closes the connection to the shared service if necessary.

Those skilled in the art will appreciate that in alternate embodiments, the specific flow of control executed by the dispatcher may vary, and that function information groups may contain additional pieces of code to be executed or may lack some of the pieces of code specified in the illustrated embodiment. In addition, those skilled in the art will appreciate that in some embodiments, a particular flnction may not support a specified messaging model, but that the dispatcher will perform additional processing as necessary (e.g., for a messaging model of request-reply with a finction that does not send a response, the dispatcher could create and send a response after the fimction execution had ended). Also, while the messaging component has been described as a single group of software in the illustrated embodiment, in alternate embodiments various fimctionality provided by the described messaging component may instead by distributed across multiple smaller and/or specialized groups of software.

The use of a messaging component to allow various disparate clients to access functionality provided by various disparate shared services provides a variety of benefits. Since messages can be complex groups of structured information, a variety of information can be exchanged. In addition, the use of messages for communication provides a loose coupling between components that allows a particular component to be replaced by another is (e.g., upgraded) component that supports the same types of messages. Moreover, legacy applications developed before the messaging component is installed can be included as part of the system, such as placing a small wrapper or adapter around the legacy application to receive messages and to invoke the appropriate legacy application finctionality. Also, the separation of business logic (such as in shared services) from presentation logic (such as will be done by clients) allows information to be displayed in a flexible manner on a wide variety of types of devices and using various client component technology. The use of the passthru component also provides additional benefits, such as by allowing external components to securely access business process shared services within a corporate intranet.

As an illustrative example, consider a situation in which a client application program executing in the application framework desires to communicate with multiple remote shared services. In this example embodiment, the access interface information for each shared service includes an executable proxy component that can receive messages from the messaging component in a standardized format and can communicate with the shared service in a manner specific to that shared service. In addition, a local service of the client application will act as a messaging component for communicating with the various remote shared services, such as the “MessagingService” service 2505 illustrated in FIG. 25.

As a specific illustrative example, a corporate environment exists in which many different application programs are used. It is desirable to have an enterprise-wide login scheme for corporate users so that such users can perform a single standardized login from any of the multiple application programs. Thus, when a new corporate user begins interacting with one of the client application programs, the client application program will first register the user in a manner accessible throughout the enterprise. In particular, an executing action handler of the client application program will invoke a user registration function named “create-user-profile” of a remote shared service named “UserRegistration” to create an enterprise-wide user profile.

The first step for the action handler to invoke the shared service finction involves retrieving an interface to the local messaging service. As discussed previously, the local messaging service will have been defmed in the configuration information for the application program and invoked during application initialization (as will the other local services for the client application), and will thus have an entry in the service table for the application program (such as the table illustrated previously with respect to FIG. 28). In the illustrated embodiment, the local messaging service is named “local-messaging”, and one of the action singletons of the application program is configured to retrieve an interface to the local messaging service at initialization and store it in an accessible manner. Table 2 below provides example Java code for an initialization routine of the action singleton that uses the “lookup” function of the environment context object (such as environment context object 2504) to retrieve and store a pointer to the interface.

TABLE 2
public void init(SingletonConfig config) throws SystemException {

try {

EnvironmentContext env = config.getEnvironmentContext();
// Retrieve a reference to the messaging service
this.messaging =

(MessagingService)env.lookup(“svc:local-messaging”);

// Attach this singleton to the action context so that it is
// accessible to action components
config.getContext().setAttribute(

“com.gepower.sfo.ssoapp.action.SharedActionResources”, this);

// Retrieve this singleton's configuration object
Iterator iter = config.getConfigsAsObjects();
ssocfg = (SSOConfig)iter.next();

}
catch (Exception ex) {

throw new ExceptionWrapper(ex);

}

}

With the pointer to the local messaging service interface accessible, the next step for the action handler to invoke the shared service function involves sending a message to the local messaging service for forwarding to an appropriate proxy component of the shared service. In the illustrated embodiment, the messaging service provides interfaces for synchronous and asynchronous messages, as illustrated below in Table 3. As can be seen, the messaging service includes two versions of the interface for synchronous messages, and two versions of the interface for asynchronous messages. Two versions of each of the interfaces are provided because the message to be sent to the proxy for the shared service can be specified as either an XML message (using the “xmlrequest” parameter) or as a JavaBean object (using the “request” parameter). For all of the interfaces, the first parameter (“service”) is a unique name of the shared service, and the second parameter “function” is a unique name of the function of the shared service to be invoked. The synchronous messages include an optional fourth parameter which if called with a non-zero value specifies a timeout for the synchronous routine.

TABLE 3

public java.lang.String send-synch(java.lang.string service,

| | java.lang.String function, |
|---|---|
| | java.lang.String xmlrequest, |
| | long mstimeout) |
| throws | MessagingException, |
| | TimeoutException |

public java.lang.Object send-synch(java.lang.String service,

| | java.lang.String function, |
|---|---|
| | java.lang.Object request, |
| | long mstimeout) |
| throws | MessagingException, |
| | TimeoutException |

public java.lang.String send-asynch(java.lang.String service,

| | java.lang.String function, |
|---|---|
| | java.lang.String xmlrequest) |
| throws | MessagingException, |
| | TimeoutException |

public java.lang.Object send-asynch(java.lang.String service,

| | java.lang.String function, |
|---|---|
| | java.lang.Object request) |
| throws | MessagingException, |
| | TimeoutException |

Using the expression “<lms-interface>” to represent the stored accessible interface to the local messaging service, the action handler can thus synchronously send a message to the local messaging service for forwarding to the specified shared service function using a format such as illustrated below in Table 4.

TABLE 4

<lms-interface>.send-synch(

“UserRegistration”,
“create-user-profile”,
“<function-params

<param name=/“UserID/” value=/“Bob23/” />
<param name=/“password/” value=/“saxophone/” />

```
  </function-params>”,
  0)
```

As is shown, the example “send-synch” message invocation includes an XML message to be sent to the shared service finction that specifies a UserID and password for the user profile to be created. Those skilled in the art will appreciate that such a finction could receive a variety of types of data in a variety of types of forms. In addition, since a value of 0 is used for the timeout value, in the illustrated embodiment the action handler will wait for a response from the local messaging service before continuing. Those skilled in the art will also appreciate that the response could take a variety of forms, such as an XML message or an integer representing a status code for success or failure.

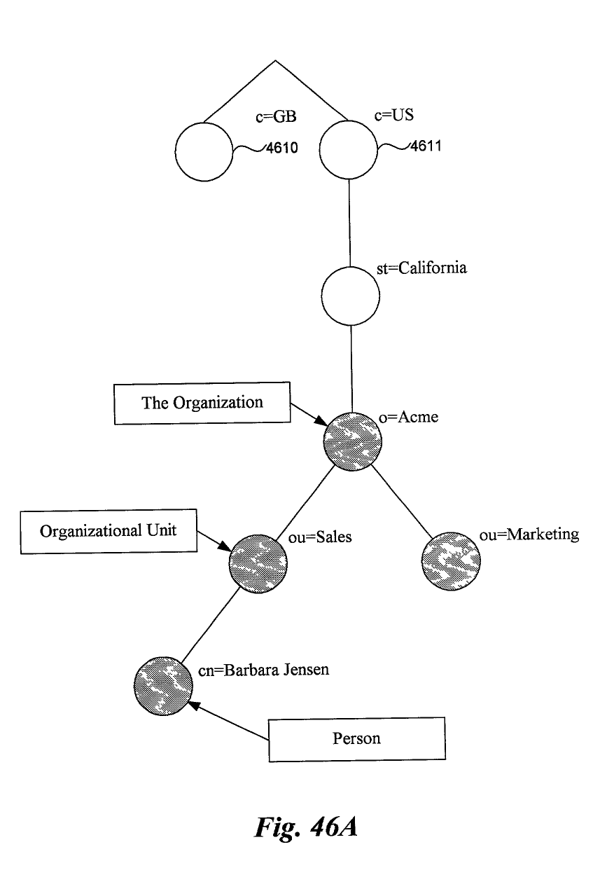

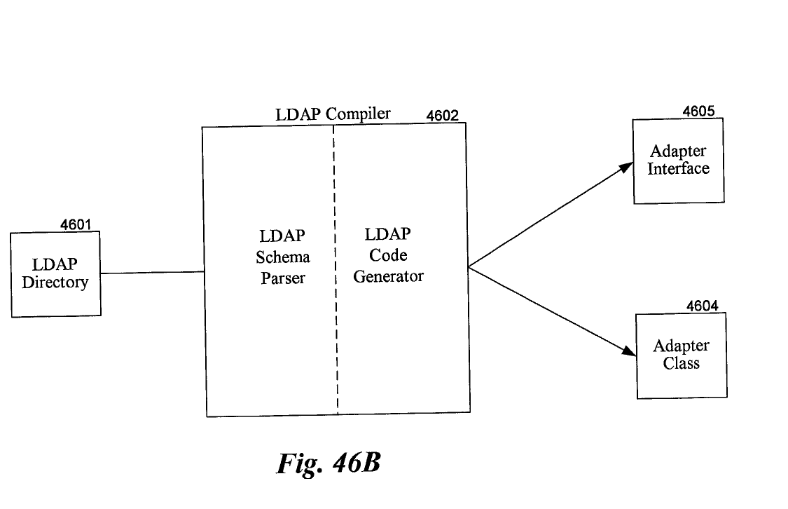

When the local messaging service “send-synch” interface method is invoked, the local messaging service determines the appropriate proxy component for the UserRegistration shared service and invokes a method in the proxy interface to pass the message to the proxy. In the illustrated embodiment, each of the shared services stores their access interface information in an LDAP directory in XML format, and the messaging service can perform an LDAP lookup using the format “cn=UserRegistration, ou=service, o=ge.com” to retrieve the appropriate LDAP entry for the UserRegistration shared service. The use of a directory service for storing configuration information such as the proxy is discussed in greater detail below with respect to FIGS. 46-53.

In the illustrated embodiment, the proxy component is an instance of a specified proxy class, and it has an interface that the messaging component can invoke to send the message to the shared service. The access interface information for the shared service includes the name of a service proxy factory class that can be used to create the proxy, and can also specify configuration information to be used by the proxy component. A “getProxyInstance” method of the factory class is invoked to create the proxy component, with the method receiving a list of name-value pairs that are specified in LDAP for the proxy (e.g., in the configuration file). The LDAP information can also specify other information related to the proxy and/or shared service, such as a communications protocol to use or authentication information for the communication. If such other information is specified, it can be used by the proxy and/or the local messaging service as appropriate. Tables 5 and 6 below illustrate examples, respectively, of access information that can be used to create the proxy for the UserRegistration shared service and a configuration file for the UserRegistration proxy.

```
TABLE 5
<?xml version=“1.0” encoding=“ISO-8859-1”?>
<!DOCTYPE messaging-config
    PUBLIC “-//GE CASPER//DTD config local-messaging-1.0//EN”
    “http://casper.ge.com/dtd/config/local-messaging-1.0.dtd”>
<messaging-config base-lookup-context=“ou=service, o=ge.com”>
  <codebase url=“file:/c:/projects/common-buildarea/middleware.jar”/>
  <codebase url=“file:/c:/apps/orion1.0/orion.jar”/>
  <codebase url=“file:/c:/apps/weblogic/lib/weblogicaux.jar”/>
  <codebase url=“file:/c:/apps/weblogic/lib/weblogic.jar”/>
  <!−− <codebase url=“http://localhost:2001/”/> −−>
</messaging-config>
```

```
TABLE 6
<?xml version=“1.0” encoding=“ISO-8859-1”?>
<!DOCTYPE service-dir-entry
    PUBLIC “-//GE CASPER//DTD sfo-service-dir-entry-1.0//EN”
    “c:/workspace/build/dtd/config/sfo-service-dir-entry-1.0.dtd”>
<service-dir-entry
  service-name=“UserRegistration”
  description=“Corporate Registration Service”>
  <service-proxy-factory
```

class-name=
“com.gepower.sfo.middleware.ejb.EjbServiceProxyFactory”>
<param name=“home” value=“UserRegistration”/>
<param name=“initial-context-factory”
value=“weblogic.jndi.WLInitialContextFactory”/>
<param name=“url” value=“t3://localhost:7001”/>
<param name=“principal” value=“system”/>
<param name=“credentials” value=“password”/>

</service-proxy-factory>
</service-dir-entry>

Thus, when the local messaging service first receives a message to be sent to a particular shared service, the local messaging service retrieves the access interface information, instantiates an appropriate service proxy factory object, and uses the service proxy factory object to create an instance of the proxy component. The local messaging service then invokes an appropriate interface of the proxy to send the message to the proxy for forwarding to the shared service in an appropriate manner. In the illustrated embodiment, each proxy component implements the same messaging interface functions as does the local messaging service, and so the local messaging service invokes a “send-synch” message of the proxy object interface using the same parameters as those shown above in Table 4. The local messaging service in the illustrated embodiment then caches the service proxy interface information, and uses it for any later requests to be sent to the shared service from any components of the application program.

Those skilled in the art will appreciate that in other embodiments the proxy components could implement interfaces that are different than that provided by the local messaging service and/or that are distinct from each other. If so, details about the proxy interfaces could also be stored in the access information for the shared service. In addition, while the single proxy component in the illustrated embodiment provided interfaces for multiple messaging models, in other embodiments a particular proxy component might support only a single messaging model (e.g., synchronous). In some such embodiments, different proxy components could be defmed and used for each messaging model provided by a particular shared service, while in other embodiments only a single messaging model may be supported for a shared service.

In addition, in some embodiments in which the shared service proxies do not support a desired messaging model, the local messaging service may provide additional functionality to implement those messaging models. For example, a particular proxy component might implement only an asynchronous messaging model. If so, and if the action handler invokes the “send-synch” message of the local messaging service to send a synchronous message to that shared service, the local messaging service could simulate a synchronous message call to the proxy by waiting until a response is received before returning a response to the action handler. Those skilled in the art will appreciate that a local messaging service could implement other messaging model types in similar ways. In other embodiments, the local messaging service could return an error if an application component requested the use of a messaging model with a shared service that the shared service did not support.

After the proxy component receives the message via the invocation of one of its interface methods, the proxy component then communicates with the shared service in a manner specific to the shared service. For example, if the shared service was a database engine, the proxy component might convert a single XML message that it received into multiple SQL calls to be sent to the shared service. After the proxy component receives a response from the shared service, it returns a response to the local messaging service.

Application program components, including the action handler, can also communicate with other remote shared services using the local messaging service in a similar manner to that described above. In particular, the local messaging service will forward received messages to an appropriate proxy component in the manner described above, and will return any response messages to the calling component.

As previously described, a passthru component is provided in some embodiments to allow external clients to access services provided by registered shared services. In the illustrated embodiment, a passthru component could be provided by creating an application program that included a single action handler and local messaging service. In this simple embodiment, the action handler would merely forward any messages received from external clients to the appropriate shared service by using the local messaging service in the manner described above. Other passthru components could also include one or more translators and one or more view components to facilitate communication with external clients, or passthru functionality could instead be one of a variety of types of actions supported by an application program.

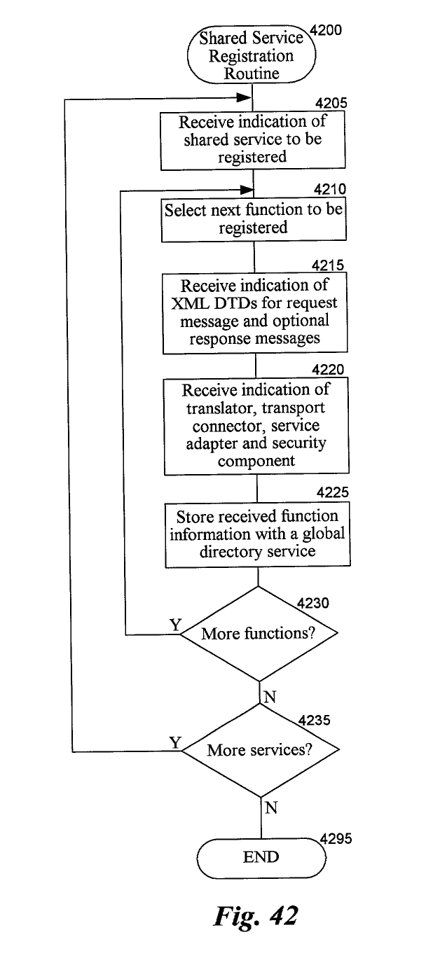

FIG. 42 is a flow diagram of an embodiment of the Shared Service Registration routine 4200. The routine receives access interface information for one more accessible functions for one more shared services, and registers the access information in a globally accessible location. The routine begins at step 4205 where it receives an indication of a shared service to be registered. The routine continues to step 4210 to select a next function to be registered for the shared service, beginning with the first function. In step 4215, the routine receives an indication of one or more XML DTDs that correspond to the request message for the function as well as to zero or more optional response messages. The routine then continues to step 4220 to receive an indication of a translator, and optionally of a transport connector (e.g., a proxy component), service adapter, and security component for the function. The routine next continues to step 4225 to store the received function information with a global directory service that is available to potential clients for the function. The routine then continues to step 4230 to determine if there are more functions to be registered for the shared service. If so, the routine returns to step 4210, and if not the routine continues to step 4235. At step 4235, the routine determines if there are more services to be registered. If so, the routine returns to step 4205, and if not the routine ends in step 4295.

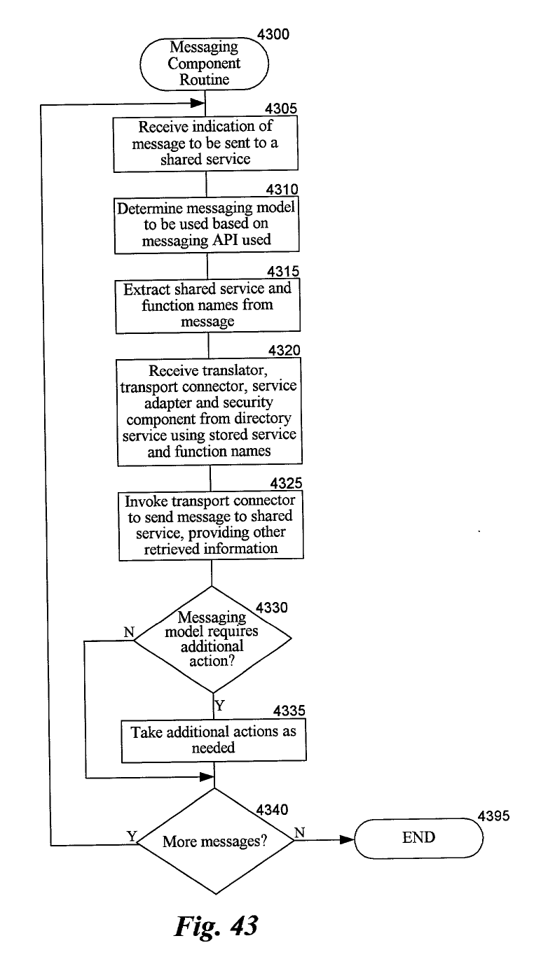

FIG. 43 is a flow diagram of an embodiment of the Messaging Component routine 4300. The routine receives messages from clients to invoke accessible functions of shared services, performs the necessary processing so that the messages are in the correct format, forwards the messages to the appropriate shared services in such a manner so as to execute the functions, and returns any response messages from the functions to the requesting clients. The routine begins at step 4305 where it receives an indication of a message to be sent to a shared service in order to execute a named function. The routine continues to step 4310 to determine the messaging model to be used for the sending of the message based on the messaging API used for the sending of the message. The routine then continues to step 4315 to extract the shared service and function names from the received message. At step 4320, the routine retrieves transport connector information for the function from a global directory service by locating stored access interface information based on the shared service name and function name, and optionally retrieves translator, service adapter, and security component information for the function if they are present in the stored access interface information.

The routine then continues to step 4325 to invoke the transport connector to send the message to the shared service, providing access to any other optionally retrieved information to the transport connector. The routine continues to step 4330 to determine if the messaging model requires that any additional action be taken at this time. If so, the routine continues to step 4335 to take the additional actions specified for the messaging model. After step 4335, or if it was instead determined in step 4330 that no additional action was needed, the routine continues to step 4340 to determine if there are more messages to be received. If so, the routine returns to step 4305, and if not the routine continues to step 4395 and ends.

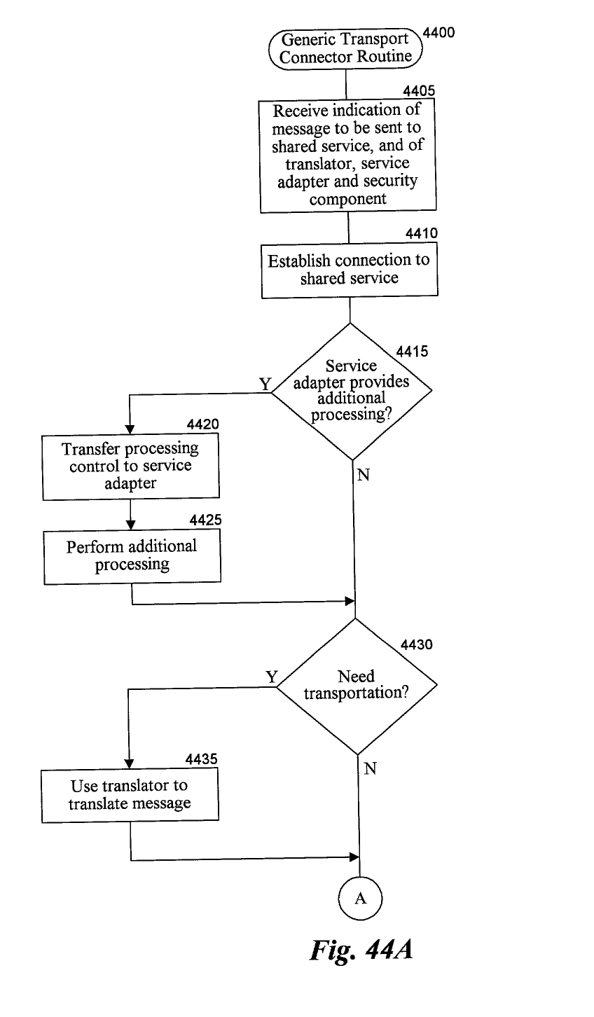

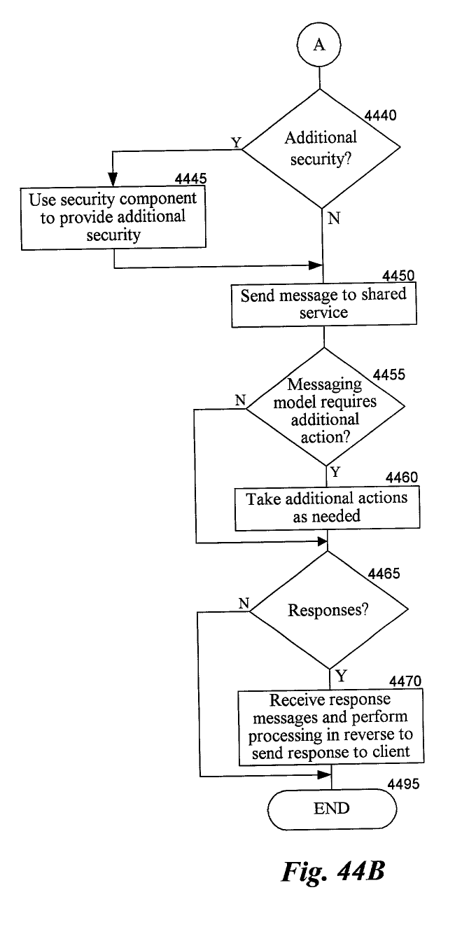

FIGS. 44A and 44B are a flow diagram of an embodiment of the Generic Transport Connector routine 4400. The routine is a generic example of a variety of specific transport connector routines. A transport connector routine is invoked by the messaging routine in order to send a message to a shared service based on a particular transport service mechanism for that routine. When invoked, the routine establishes a connection based on the particular transport service, executes a service adapter, translator, and security component if provided, sends the message to the shared service using the particular transport service, and receives and processes any response messages. The routine begins at step 4405 where it receives an indication of a message to be sent to a shared service, as well as optionally receiving an indication of a translator, service adapter, and/or security component. The routine then continues to step 4410 to establish a connection to the shared service based on a particular transport service mechanism for the routine. The routine then continues to step 4415 to determine if a service adapter has been provided to perform additional processing. If so, the routine continues to step 4420 to transfer processing control to an executing copy of the service adapter. Additional processing is then performed under the control of the service adapter in step 4425, and control then returns to the routine.

After step 4425, or if it was instead determined in step 4415 that no service adapter was provided, the routine continues to step 4430 to determine if a translator was provided. If so, the routine continues to step 4435 to use the translator to translate the provided message. After step 4435, or if it was instead determined in step 4430 that no translator was provided, the routine continues to step 4440 to determine if a security component was provided. If so, the routine continues to step 4445 to provide additional security by executing the provided security component. After step 4445, or if it was instead determined in step 4440 that no security component was provided, the routine continues to step 4450 where the message is sent to the shared service using the particular transport service mechanism. The routine then continues to step 4455 to determine whether the current messaging model requires additional action to be taken at this time. If so, the routine continues to step 4460 to take additional actions as needed. After step 4460, or if it was instead determined in step 4455 that no additional actions were needed, the routine continues to step 4465 to determine if any response messages are to be received. If so, the routine continues to step 4470 to receive the one or more response messages, and to process the response messages in reverse order and then send the response messages back to the requesting client. After step 4470, or if it was instead determined in step 4465 that no response messages were to be received, the routine continues to step 4495 and ends.

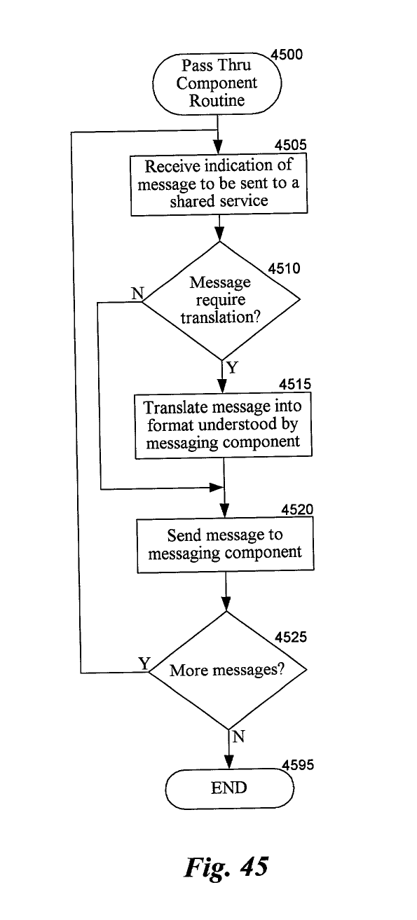

FIG. 45 is a flow diagram of an embodiment of the PassThru Component routine 4500. The routine receives messages from external clients that are to be sent to a shared service, processes the messages if necessary so that they are in a format appropriate for the messaging component, and then forwards the messages to the messaging component for processing. The routine begins in step 4505 where it receives an indication of a message to be sent to a shared service in order to execute an accessible function of the shared service. The routine then continues to step 4510 to determine if the message requires translation to be understood by the messaging component. If so, the routine continues to step 4515 to translate the message into a format understandable by the messaging component. After step 4515, or if it was instead determined in step 4510 that the message did not require translation, the routine continues to step 4520 to forward the message to the messaging component. In embodiments in which a response is received from the messaging component, the routine returns the response to the external client. The routine then continues to step 4525 to determine if there are more messages to be forwarded. If so, the routine returns to step 4505, and if not the routine continues to step 4595 and ends.

As previously noted, some embodiments store shared service access interface information using a globally accessible directory service such as LDAP. Computer systems often use such directory services, which are specialized databases for providing access to attribute-based data, to store characteristics relating to equipment and users. The directories typically contain descriptive information and support sophisticated filtering capabilities. A directory service typically does not need to provide the support necessary for complicated transactions or roll-back schemes employed by database management systems designed for handling high-volumes of transactions, and are instead typically optimized for high-volume lookup and quick response.

One popular directory service, LDAP, is provided by the Open LDAP organization (www.openldap.org). LDAP uses a directory model that provides a hierarchical, tree-like structure of directory entries. For example, the structure typically reflects the geographic or organizational boundaries of the organization that uses the directory. Directory entries that represent countries are at the top of the hierarchy, and directory entries that represent states and national organizations are lower in the hierarchy. FIG. 46A represents a directory hierarchy. Each node of a hierarchy represents a directory entry. Nodes (or directory entries) 4610 and 4611 represent the countries Great Britain and the U.S. Each directory entry has attributes associated with it (e.g., country name). The attributes may be required or optional. Each directory entry also has an objectclass attribute (not shown) that specifies the schema for the directory entry. LDAP defines operations for interrogating and updating the directory entries. These operations are typically provided through an application programming interface (“API”).

A difficulty with accessing the LDAP directory service via such an API is that many application programs are developed using an object-oriented model, and the use of such an API is not consistent with such an object-oriented model. It would thus be desirable to have a technique for accessing a directory service that was consistent with an object-oriented model. Accordingly, in some embodiments an object-oriented interface to a directory service is provided using a directory compiler and directory interface objects as described below, and this object-oriented interface is used for storing and retrieving shared service access interface information from the directory service.

In particular, the directory compiler inputs a schema of a directory and outputs the definitions of various interfaces and objects (e.g., adapters) related to that directory. An application program can then use the interfaces and adapter objects to access the directory in an object-oriented manner. The directory compiler includes a schema parser and a code generator. The schema parser identifies the classes of objects that are defmed by the directory. Each class of object is identified by a class name and the attributes within that class. The attributes have a corresponding characteristic or attribute type. The code generator then outputs an interface definition and an adapter class definition for each class of the directory. For example, a directory may include entries related to employees of a company. The schema may include a class relating to address information of the employees and another class relating to the experience of the employee. The class relating to address information may include the attributes of street address, city, and state. The schema compiler generates an interface definition for each class and a class definition for accessing the attributes associated with the class.

In one embodiment, an object-oriented interface to an LDAP directory service is used. In addition to storing shared service access interface information, the LDAP directory service may also provide an enterprise-wide accessible location for storing other shared data such as user group identification, user profiles and preferences, access control information, and general resource information. The directory includes a schema and entries. The schema defines the objectclasses of information that can be stored in the entries. Each entry has a unique key, a list of objectclasses of the information contained within the entry, and the values associated with the attributes of each objectclass.

At runtime, an application can access the directory using the object-oriented interface. The interface system provides a directory manager object for retrieving entries from the directory. Each entry is represented by a directory entry object, and each objectclass of a directory entry is represented by an adapter object. To access the directory, an application instantiates a directory manager object for the directory of interest. The application then uses the methods of the directory manager object to retrieve directory entry objects, each corresponding to a directory entry. The application also uses the methods of the directory manager object to retrieve adapter objects, each corresponding to an objectclass associated with a directory entry. The adapter objects provide “set” and “get” methods for setting and retrieving the attributes associated with the directory entry.

FIG. 46B is a block diagram illustrating the directory compiler. The directory compiler 4602 inputs schema information from the LDAP directory 4601 and outputs an adapter interface definition 4605 and an adapter class definition 4604 for each class defined in the LDAP directory. The LDAP schema parser identifies the classes, attributes, and attribute characteristics from the schema of the LDAP directory. The LDAP code generator then generates the interface and adapter definitions. The “Class Generator” section of Appendix A describes a class that can be used to generate interface and adapter definitions for the classes.

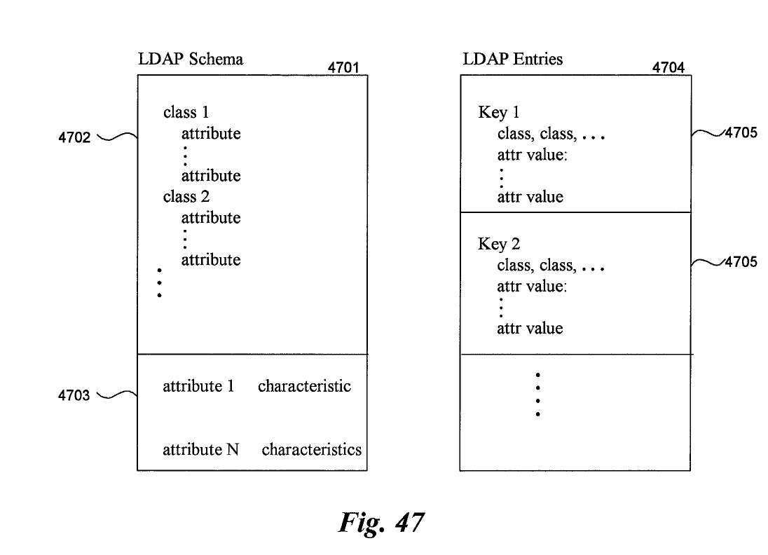

FIG. 47 is a block diagram illustrating an LDAP schema and LDAP directory entries. The LDAP schema 4701 contains an objectclass definition section 4702 and attribute section 4703. The class definition section identifies each objectclass used by the directory along with the attributes defined for that class. For example, an objectclass may be named “employee address information” and may contain the attributes street address, city, and state. The attributes section identifies each attribute that can be used by an objectclass, along with the characteristics of that attribute. The characteristics may include the attribute type, such as integer or whether the attribute is multi-valued. Each LDAP entry includes a unique key, the list of objectclasses associated with that entry, and a list of attribute/value pairs. The attribute/value pairs identify the current value associated with the attributes of the objectclasses of the entry.

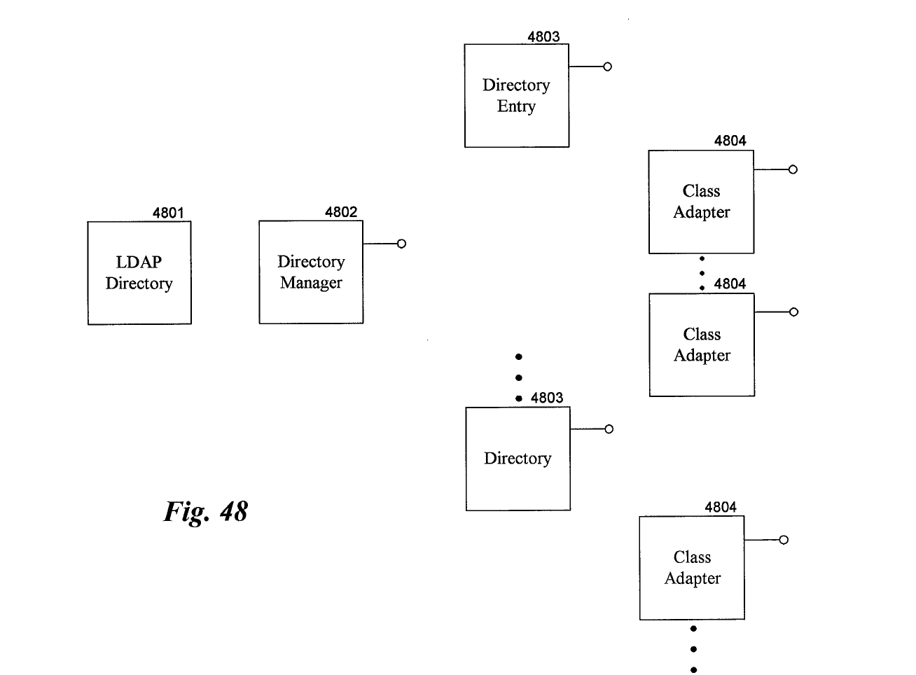

FIG. 48 is a block diagram illustrating the objects generated to access an LDAP directory. A directory manager object 4802 corresponds to the LDAP directory 4801. The directory manager object provides methods for accessing the data of the directory entries. Each directory entry is represented by a directory entry object 4803. The directory entry objects provide a method for retrieving the current context (i.e., the actual directory entry) of a directory entry. Each adapter class provides methods for setting and retrieving the attribute values of a class associated with the directory entry. The “Interface IBaseObjectClass” and the “Class BaseDirectoryAdapter” sections of Appendix A describe the methods of an adapter object. The “Class DirectoryEntry” section of Appendix A describes the methods of the directory entry object. The “Class DirectoryManager” section of Appendix A describes the methods of the directory manager object.

In an alternate embodiment, the interface system uses a dynamic proxy class (not to be confused with a shared service proxy component) defmed by the Java 2 Platform Standard Edition v1.3 provided by Sun Microsystems. Appendix B contains a description of the dynamic proxy class capabilities. The dynamic proxy class implements a list of interfaces specified at runtime when the class is instantiated. An invocation handler is also specified when the class is instantiated. An application program uses a proxy instance by casting the instance to the interface to be accessed. When the application invokes one of the methods of a cast-to interface, the proxy instance invokes the invocation handler which in turn invokes the corresponding method on the object that implements the interface. The use of a dynamic proxy class allows the application program to access objectclasses and attributes that may have been added to the LDAP directory after the application program was created.

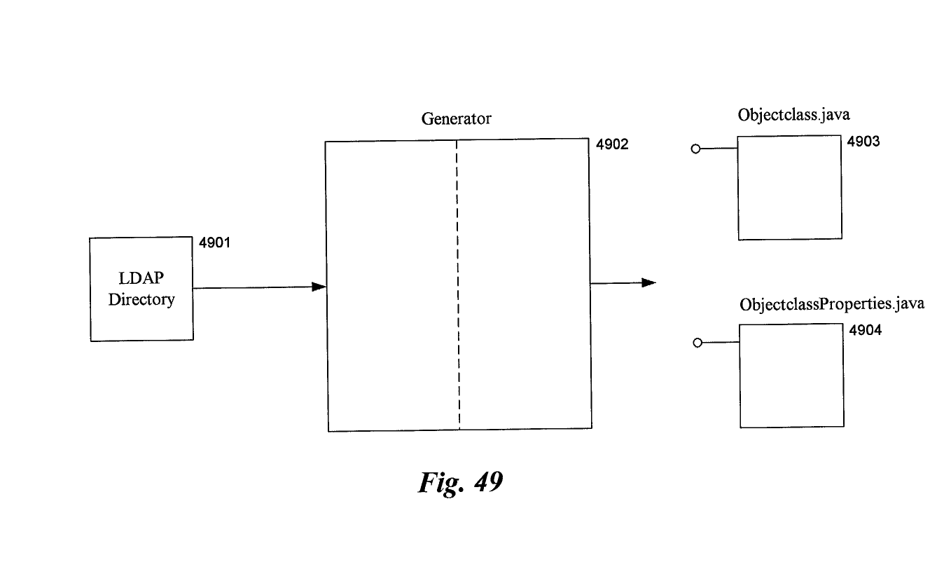

FIG. 49 is a block diagram illustrating components of the interface system in this alternate embodiment. The interface system includes LDAP directory 4901, generator 4902, Java objects 4903, and Java property objects 4904. The generator is a class that imports an LDAP directory and generates the Java classes and Java property classes corresponding to the directory entries of the LDAP directory. The generator retrieves each of the directory entries and generates a corresponding Java class with a set and get method for each attribute of the objectclasses of the directory entry. The generator names the Java class with the same name as the name of the objectclass.

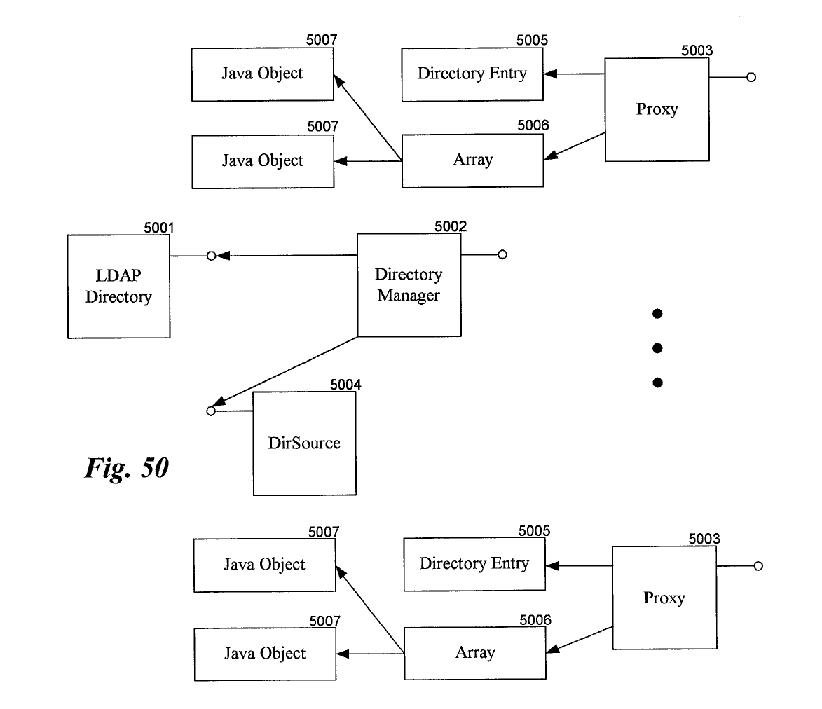

FIG. 50 is a block diagram illustrating objects instantiated during runtime of an application. The objects include an LDAP directory object 5001, a directory manager object 5002, proxy objects 5003, a directory source object 5004, directory entry objects 5005, arrays 5006, and Java objects 5007. An application program uses a directory manager factory object (not shown) to instantiate a directory manager object that provides access to an LDAP directory that is specified by the directory source object. The directory source object is passed to the directory manager factory object when the directory manager object is instantiated. The directory manager object provides a lookup method for retrieving proxy objects for LDAP entries. Once an application program retrieves a proxy object, it casts that proxy object to the interface to be accessed. When a proxy object is instantiated by the interface system, it is provided with a directory entry object and an array of references to Java objects that implement those interfaces. The Java objects correspond to the Java classes generated by the generator. When a method of a cast proxy object is invoked by an application, the method invokes the invoke method of the directory entry object passing an identifier of the method invoked by the application and the arguments. The invoke method identifies the Java object from the array and invokes the appropriate method of the Java object. The invoked method of the Java object then accesses the LDAP directory directly.

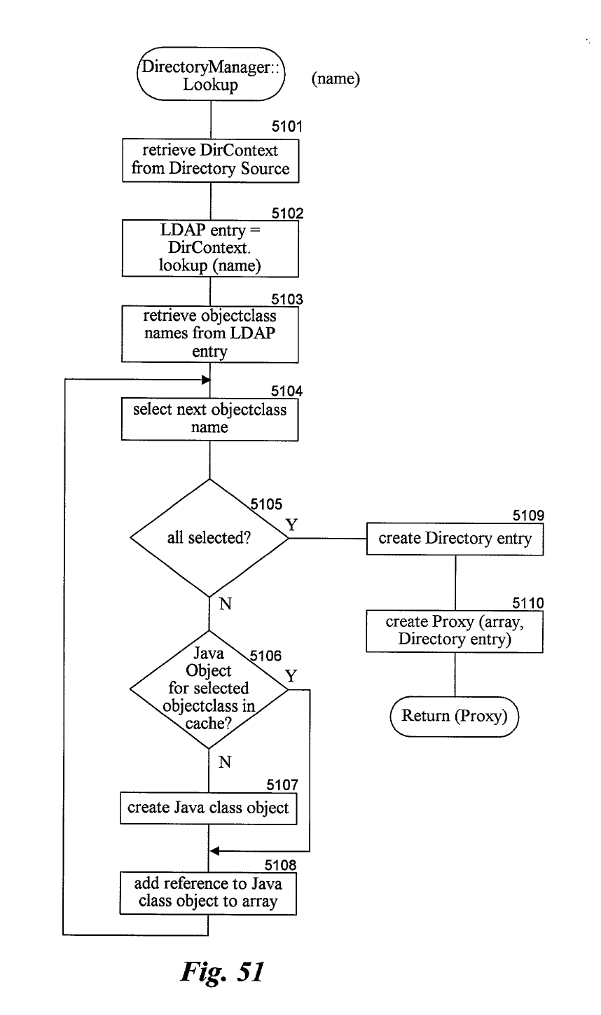

FIG. 51 is a flow diagram of the lookup method of a directory manager object in one embodiment. The lookup method is passed the name of an LDAP directory entry and returns a proxy object corresponding to that directory entry. In block 5101, the method retrieves directory context information from the directory source object. Appendix C contains definition of the interfaces used in this embodiment of the interface system. In block 5102, the method retrieves the data of the LDAP directory entry. In block 5103, the method retrieves the objectclass names for the LDAP directory entry. In blocks 5104-5108, the method loops instantiating an object for each objectclass name. In block 5104, the method selects the next objectclass name. In decision block 5105, if all the objectclass names have already been selected, then the method continues at block 5109, else the method continues at block 5106. In decision block 5106, if the Java object for the selected objectclass has already been instantiated, then the method continues at block 5108, else the method continues at block 5107. In block 5107, the method instantiates a Java object for the selected objectclass name. The method instantiates the Java object using the class definitions generated by the generator. In block 5108, the method adds a reference to the Java object to the array of interfaces and loops to block 5104 to select the next objectclass name. In block 5109, the method instantiates a directory entry object. In block 5110, the method instantiates a proxy object passing the array of interfaces and the directory entry object to use as an invocation handler. The method then returns a reference to the proxy object.

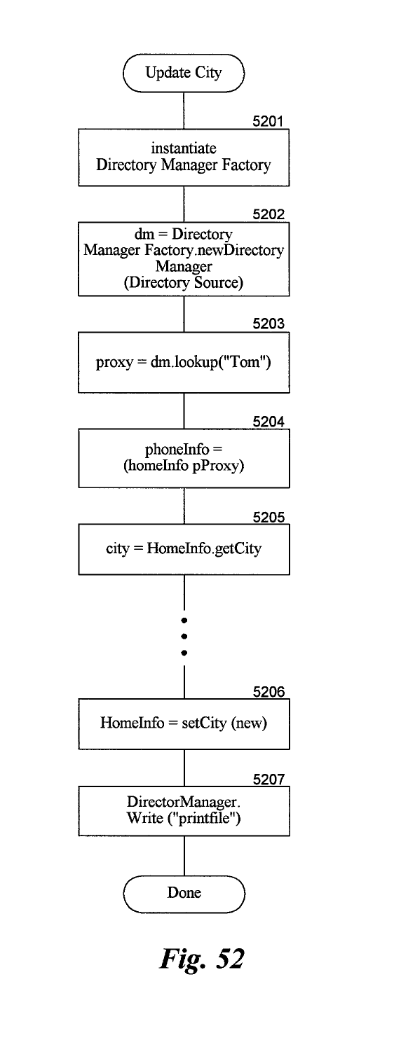

FIG. 52 is a flow diagram illustrating an application using a proxy object. In block 5201, the application instantiates a directory manager factory object. In block 5202 the application invokes the new directory manager method of the directory manager factory object to instantiate a new directory manager object. The application passes to the directory manager factory object a directory source object specifying the LDAP directory. In block 5203, the application invokes the lookup method of the directory manager object and receives a reference to the proxy object in return. In block 5204, the application casts the proxy object to an interface associated with the LDAP directory entry. In block 5205, the application invokes a method of that interface to retrieve an attribute value. In block 5206, the application invokes another method of the cast proxy interface to set an attribute value. In block 5207, the application invokes of the write method of the directory manager object to commit the changes to the LDAP directory entry. The application then completes.

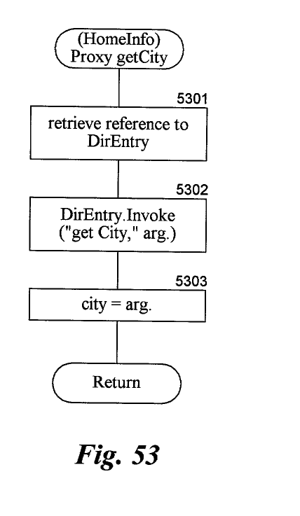

FIG. 53 is a flow diagram illustrating a method of a proxy object in one embodiment. In block 5301, the method retrieves a reference to the directory entry object. In block 5302, the method invokes the invoke method of the directory entry object passing the name of the method to invoke and the arguments to be passed to that invoked method. In block 5303, the method retrieves the returned arguments and then returns.

Those skilled in the art will also appreciate that in some embodiments the functionality provided by the various routines discussed above may be provided in alternate ways, such as being split among more routines or consolidated into less routines. Similarly, in some embodiments illustrated routines may provide more or less functionality than is described, such as when other illustrated routines instead lack or include such functionality respectively, or when the amount of functionality that is provided is altered. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims. In addition, while certain aspects of the invention are presented below in certain claim forms, the inventors contemplate the various aspects of the invention in any available claim form. For example, while only one some aspects of the invention may currently be recited as being embodied in a computer-readable medium, other aspects may likewise be so embodied. Accordingly, the inventors reserve the right to add additional claims after filing the application to pursue such additional claim forms for other aspects of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A method in a computer system for executing applications to request services from remote shared service providers each able to provide services to multiple executing applications, each remote shared service provider having an associated distinct proxy component for communicating with the remote shared service provider, comprising:
under control of a first of the executing applications,
instantiating a local messaging component within the first application, the local messaging component able to communicate with each of the associated proxies;
notifying the local messaging component to request a specified service from a remote shared service provider identified with a unique name; and
under control of the local messaging component, requesting the specified service by,
determining based on the unique name identified in the notification to request the specified service from a first of the remote shared service providers;
retrieving configuration information for the first remote shared service provider that identifies a first proxy component associated with the first remote shared service provider;
when the first proxy component is not already instantiated within the first application, instantiating the first proxy component within the first application;
sending a message to the first proxy component requesting that the first remote shared service provider provide the specified service; and
receiving a response from the first remote shared service provider via the first proxy component, and notifying the first application of the received response, so that an application can communicate with any of the remote shared service providers via a local messaging component that interacts with a proxy component associated with the remote shared service provider.

2. The method of claim 1 including, under control of the first application:
notifying the local messaging component to request a second specified service from a remote shared service provider identified with a second unique name; and
under control of the local messaging component, requesting the second specified service by,
determining based on the second unique name identified in the notification to request the second specified service from a second of the remote shared service providers;
retrieving configuration information for the second remote shared service provider that identifies a second proxy component associated with the second remote shared service provider;
sending a message to the second proxy component requesting that the second remote shared service provider provide the second specified service; and
receiving a response from the second remote shared service provider via the second proxy component, and notifying the first application of the received response.

3. The method of claim 1 including:
under control of a second of the executing applications,
instantiating a second local messaging component within the second application, the second local messaging component able to communicate with each of the associated proxies;
notifying the second local messaging component to request a specified service from a remote shared service provider identified with the unique name of the first shared service provider; and
under control of the second local messaging component, requesting the specified service by,
determining based on the unique name identified in the notification to request the specified service from the first remote shared service provider;
retrieving the configuration information for the first remote shared service provider that identifies the associated first proxy component;
when the first proxy component is not already instantiated within the second application, instantiating the first proxy component within the second application; and
sending a message to the first proxy component requesting that the first remote shared service provider provide the specified service.

4. The method of claim 1 including, under control of the first proxy component:
receiving the sent message from the local messaging component;
identifying based on the received message one of multiple services provided by the first remote shared service provider that is requested;
requesting the first remote shared service provider to provide the identified service;
receiving a response from the first remote shared service provider; and
sending the received response to the local messaging component.

5. The method of claim 4 including, under control of the first remote shared service provider:
receiving the request from the first proxy component to provide the identified service;
performing processing associated with the identified service, the processing generating a response; and
sending the generated response to the first proxy component.

6. The method of claim 1 wherein the first remote shared service provider has multiple associated proxy components each for communicating with the first remote shared service provider to request distinct services provided by the first remote shared service provider, wherein the notifying of the local messaging component further identifies a name of the specified service, and wherein the identifying of the first proxy component from the retrieved configuration information is based at least in part on the identified name of the specified service.

7. The method of claim 1 wherein the local messaging component and the first proxy component are software modules, and wherein the instantiating of the components within the first application includes executing the software modules.

8. The method of claim 1 wherein the local messaging component and the first proxy component are instances of object classes, and wherein the instantiating of the components within the first application includes creating the instances.

9. The method of claim 8 wherein the notifying of the local messaging component includes invoking an interface method of the local messaging component instance.

10. The method of claim 8 wherein the sending of the message to the first proxy component includes invoking an interface method of the first proxy component instance.

11. The method of claim 1 wherein the configuration information is retrieved from storage via a directory service using the unique name of the first remote shared service provider.

12. The method of claim 11 including, before the executing of the first application, storing the configuration information using the directory service.

13. The method of claim 1 wherein the retrieved configuration information includes initialization information for the first proxy component, and wherein the instantiating of the first proxy component includes providing the initialization information to the first proxy component for use as part of its initialization.

14. The method of claim 1 wherein the notifying of the request of the specified service includes a message to be sent to the first remote shared service provider, and wherein the message sent to the first proxy component is the included message.

15. The method of claim 1 wherein the notifying of the request of the specified service includes a message to be sent to the first remote shared service provider, and wherein the message sent to the first proxy component is a version of the included message that is transformed under the control of the local messaging component before the sending.

16. The method of claim 1 wherein the first application includes multiple action handler components each for responding to requests from external clients with responses generated in a format used by the action handler component, and wherein the notifying of the request of the specified service is prompted by a request generated by one of the action handler components.

17. The method of claim 16 wherein the first application includes multiple view handler components each for transforming generated responses in formats used by action handler components into formats compatible with external clients, and including, after the notifying of the received response from the first remote shared service provider, using one of the view handler components to transform the received response into a format compatible with an external client.

18. A computer-readable medium whose contents cause a computing device to execute applications able to request services from remote shared service providers each able to provide services to multiple executing applications, each remote shared service provider having an associated proxy component for communicating with the remote shared service provider, by:
under control of a first of the executing applications,
instantiating a local messaging component, the local messaging component able to communicate with each of the associated proxies;
notifying the local messaging component to request a specified service from a remote shared service provider; and
under control of the local messaging component, requesting the specified service by,
determining based on the notifing to request the specified service from a first of the remote shared service providers;
retrieving configuration information for the first remote shared service provider that identifies a first proxy component associated with the first remote shared service provider;
when the first proxy component is not already instantiated, instantiating the first proxy component;
sending a message to the first proxy component requesting that the first remote shared service provider provide the specified service; and
receiving a response from the first remote shared service provider via the first proxy component.

19. A computing device for executing applications to request services from remote shared service providers each able to provide services to multiple executing applications, each remote shared service provider having an associated proxy component for communicating with the remote shared service provider, comprising:
a first application capable of, during execution, instantiating a local messaging component able to communicate with each of the associated proxies and of notifying the local messaging component to request a specified service from a remote shared service provider; and
the local messaging component capable of, during execution, determining based on the notification to request the specified service from a first of the remote shared service providers, of retrieving configuration infornation for the first remote shared service provider that identifies a first proxy component associated with the first remote shared service provider, of instantiating the first proxy component, of sending a message to the first proxy component requesting that the first remote shared service provider provide the specified service, and of receiving a response from the first remote shared service provider via the first proxy component.

20. A method in a computer system for an executing application to communicate with remote services via a local messaging service, each of the remote services having an associated proxy for communicating with the remote service, the method comprising:
for each of multiple of the remote services,
notifying the local messaging service to send a message to the remote service;
under control of the local messaging service,
identifying the proxy associated with the remote service by retrieving information associated with the remote service; and
sending the message to the identified proxy for communication to the remote service; and
receiving a response to the sent message from the remote service via the identified proxy.

21. The method of claim 20 including, under control of each of the identified proxies:
receiving the sent message from the local messaging service that is to be communicated to a remote service;
sending the received message to the remote service;
receiving a response from the remote service; and
sending the received response to the local messaging service.

22. The method of claim 21 including, before the sending of the received message to the remote service, transforming the received message into a format appropriate for the remote service.

23. The method of claim 20 wherein each of the remote services has multiple associated proxies, wherein the notifying of the local messaging service identifies a manner of sending the message to the remote service, and wherein the identifying of the associated proxy from the retrieved information includes selecting one of the multiple associated proxies based at least in part on the identified manner.

24. The method of claim 20 wherein the local messaging service and the proxies are created objects, and including creating the objects.

25. The method of claim 20 wherein the information associated with a remote service is retrieved from a directory service using a unique name of the remote service.

26. The method of claim 25 including storing the associated information with the directory service before the retrieving.

27. The method of claim 20 wherein the application includes multiple action handlers each able to respond to requests from external clients with responses generated in a format used by the action handler, and wherein the notifying of the local messaging service to send the messages is prompted by requests generated by the action handlers.

28. The method of claim 27 wherein the application includes multiple view handlers each able to transform a generated response in a format used by an action handler into a format compatible with at least one of the external clients, and including, after the receiving of the response from the remote service, using one of the view handlers to transform the received response into a format compatible with an external client.

29. A computer-readable medium whose contents cause a computing device to execute an application able to communicate with remote services via a local messaging service, each of the remote services having an associated proxy for communicating with the remote service, by:
for each of multiple of the remote services,
notifying the local messaging service to send a message to the remote service;
under control of the local messaging service,
identifying the proxy associated with the remote service by retrieving information associated with the remote service; and
sending the message to the identified proxy for communication to the remote service; and
receiving a response to the sent message from the remote service via the identified proxy.

30. The computer-readable medium of claim 29 wherein the computer-readable medium is a data transmission medium transmitting a generated data signal containing the contents.

31. The computer-readable medium of claim 29 wherein the computer-readable medium is a memory of a computer system.

32. A computing device for executing an application to communicate with remote services via a local messaging service, each of the remote services having an associated proxy for communicating with the remote service, comprising:
an application capable of, for each of multiple of the remote services, notifying the local messaging service to send a message to the remote service and receiving a response to the sent message from the remote service via a proxy associated with the remote service; and
the local messaging service capable of identifying the proxy associated with the remote service by retrieving information associated with the remote service and of sending the message to the identified proxy for communication to the remote service.

33. A computer system for executing an application to communicate with remote services via a local messaging service, each of the remote services having an associated proxy for communicating with the remote service, comprising:
means for, for each of multiple of the remote services, notifying the local messaging service to send a message to the remote service and receiving a response to the sent message from the remote service via a proxy associated with the remote service; and
means for identifying the proxy associated with the remote service by retrieving information associated with the remote service and sending the message to the identified proxy for communication to the remote service.

34. A method in a computer system for invoking functions of remote applications, each of the remote applications having an associated proxy for communicating with the remote application, the method comprising:
for each of multiple of the remote applications,
receiving a request to invoke a specified function of the remote application using at least one specified parameter value;
retrieving information associated with the remote application that identifies the proxy associated with the remote application;
when a copy of the identified proxy has not already been instantiated, instantiating a copy of the identified proxy;
notifying the identified proxy copy of the specified function and the specified parameter values;
under control of the identified proxy copy, invoking the specified function of the remote application using the specified parameter values; and
receiving a response from the invoking of the specified function.

35. The method of claim 34 wherein each of the remote applications has multiple associated proxies for invoking distinct functions of the remote application, and wherein the identifying of the proxy associated with the remote application from the retrieved information is based at least in part on the specified function.

36. The method of claim 34 wherein the proxies are object instances, and wherein the instantiating of the proxies includes creating the object instances.

37. The method of claim 34 wherein the information is retrieved from a directory service using an identified name of the remote application.

38. The method of claim 34 wherein the retrieved information includes initialization information for the identified proxy, and wherein the instantiating of the proxy includes providing the initialization information to the proxy for use during initialization.

39. The method of claim 34 wherein the application includes multiple action handlers each able to respond to requests from external clients with responses generated in a format used by the action handler, and wherein the request to invoke the specified function is received from one of the action handler components.

40. The method of claim 39 wherein the application includes multiple view handlers each able to transform responses in formats used by action handlers into formats compatible with external clients, and including, after the receiving of the response from the invoking of the specified function, using one of the view handler components to transform the received response into a format compatible with an external client.

41. A computer-readable medium whose contents cause a computing device to invoke functions of remote applications each having an associated proxy for communicating with the remote application, by:
for each of multiple of the remote applications,
receiving a request to invoke a specified function of the remote application using at least one specified parameter value;
retrieving information associated with the remote application that identifies the proxy associated with the remote application;
when a copy of the identified proxy has not already been instantiated, instantiating a copy of the identified proxy,
notifying the identified proxy copy of the specified function and the specified parameter values;
under control of the identified proxy copy, invoking the specified function of the remote application using the specified parameter values; and
receiving a response from the invoking of the specified function.

42. A computing device for invoking functions of remote applications each having an associated proxy for communicating with the remote application, comprising:
a first component capable of, for each of multiple of the remote applications, receiving a request to invoke a specified function of the remote application using at least one specified parameter value, retrieving information associated with the remote application that identifies the proxy associated with the remote application, instantiating a copy of the identified proxy, notifying the identified proxy copy of the specified function and the specified parameter values, and receiving a response from the invoking of the specified function; and
multiple proxy copies each capable of receiving a notification of a specified function and specified parameter values for one of the remote applications and of invoking the specified function of the remote application using the specified parameter values.

43. A method in a computer system for components of an executing application to communicate with remote services, each of the remote services having an associated proxy for communicating with the remote service, the executing application having a messaging service component for communicating with the associated proxies, having multiple action handler components each for responding to requests with responses generated in a format used by the action handler component, and having multiple view handler components each for transforming generated responses in formats used by action handler components into formats compatible with external clients, the method comprising:
under control of each of multiple of the action handler components,
receiving a request from a remote client to provide a service; and
providing the requested service by,
determining a need for functionality available from one of the remote services;
notifying the local messaging component to request the needed functionality from the one remote service;
receiving a response from the one remote service via the local messing component;
generating a response in a format used by the action handler component;
determining a view handler component able to transform the generated response from the format used by the action handler component to a format compatible with the remote client; and
providing the generated response to the determined view handler component for the transforming;
under control of the local messaging component,
receiving notifications from multiple action handler components each to request flmctionality from a remote service; and
for each received notification,
identifying the proxy associated with the remote service; and
sending a request for the functionality to the identified proxy for communication to the remote service;
receiving a response to the sent request from the remote service via the identified proxy; and
notifying the action handler component of the received response; and
under control of each of multiple of the view handler components,
receiving responses generated by at least one action handler component in a format used by the action handler component; and
for each received response, transforming the received response into a format that is compatible with the remote client for whom the received response was generated.
